(19) United States
(12) Patent Application Publication
(10) Pub. No.: US 2023/0052258 A1
(43) Pub. Date: Feb. 16, 2023

(54) PROVIDING RELEVANT INFORMATION DURING ONLINE MEETINGS

(71) Applicant: Citrix Systems, Inc., Fort Lauderdale, FL (US)

(72) Inventors: Arnav Akhoury, Jamshedpur (IN); Divyansh Deora, Jaipur (IN); Achyuth Nandikotkur, Hyderabad (IN); Satish Vanahalli, Bangalore (IN)

(21) Appl. No.: 17/402,971

(22) Filed: Aug. 16, 2021

(51) Int. Cl. G10L 15/22; G06F 16/632; G06F 16/2457; G06F 21/31; G10L 15/26; G06F 3/0482

(52) U.S. Cl. CPC G10L 15/22; G06F 16/634; G06F 16/24575; G06F 21/31; G10L 15/26; G06F 3/0482

(57) ABSTRACT

One disclosed method involves determining, by at least one computing system and based at least in part on input provided to a meeting application, at least a first topic of interest for a first user accessing the meeting application via a first client device, in response to determining the first topic of interest, querying, by the at least one computing system, at least one data source, external to the meeting application, for information corresponding to the first topic of interest, and causing, by the at least one computing system, the first client device to display a representation of the information.

### BACKGROUND

Various systems have been developed that allow client devices to access applications and/or data files over a network. Certain products offered by Citrix Systems, Inc., of Fort Lauderdale, Fla., including the Citrix Workspace™ family of products and the Virtual Apps and Desktops™ systems, provide such capabilities.

### SUMMARY

This Summary is provided to introduce a selection of concepts in a simplified form that are further described below in the Detailed Description. This Summary is not intended to identify key features or essential features, nor is it intended to limit the scope of the claims included herewith.

In some of the disclosed embodiments, a method may involve at least one computing system determining, based at least in part on input provided to a meeting application, at least a first topic of interest for a first user accessing the meeting application via a first client device, in response to determining the first topic of interest, querying at least one data source, external to the meeting application, for information corresponding to the first topic of interest, and causing the first client device to display a representation of the information.

In some disclosed embodiments, a computing system may comprise at least one processor at least one computer-readable medium encoded with instructions which, when executed by the at least one processor, cause the computing system to determine, based at least in part on input provided to a meeting application, at least a first topic of interest for a first user accessing the meeting application via a first client device, in response to determining the first topic of interest, query at least one data source, external to the meeting application, for information corresponding to the first topic of interest, and cause the first client device to display a representation of the information.

In some disclose embodiments, at least one non-transitory computer-readable medium may be encoded with instructions which, when executed by at least one processor of a computing system, cause the computing system to determine, based at least in part on input provided to a meeting application, at least a first topic of interest for a first user accessing the meeting application via a first client device, in response to determining the first topic of interest, query at least one data source, external to the meeting application, for information corresponding to the first topic of interest, and cause the first client device to display a representation of the information.

### BRIEF DESCRIPTION OF THE DRAWINGS

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

FIG. 1A shows an example implementation of a system for providing relevant information during an online meeting, in accordance with some embodiments of the present disclosure;

FIG. 1B shows an example user interface screen during an online meeting;

FIG. 1C shows an example user interface screen that presents relevant information to a user during the online meeting;

FIG. 2 is a diagram of a network environment in which some embodiments of the user customizable activity feed generation system disclosed herein may deployed;

FIG. 3 is a block diagram of a computing system that may be used to implement one or more of the components of the computing environment shown in FIG. 2 in accordance with some embodiments;

FIG. 4 is a schematic block diagram of a cloud computing environment in which various aspects of the disclosure may be implemented;

FIG. 5A is a block diagram of an example system in which resource management services may manage and streamline access by clients to resource feeds (via one or more gateway services) and/or software-as-a-service (SaaS) applications;

FIG. 5B is a block diagram showing an example implementation of the system shown in FIG. 5A in which various resource management services as well as a gateway service are located within a cloud computing environment;

FIG. 5C is a block diagram similar to that shown in FIG. 5B but in which the available resources are represented by a single box labeled “systems of record,” and further in which several different services are included among the resource management services;

FIG. 6A is a block diagram illustrating key components of a resource delivery system which may be useful for practicing embodiments described herein;

FIG. 6B illustrates an example deployment of a resource delivery system such as that shown in FIG. 6A;

FIG. 6C illustrates an example process for handling user connections within the deployment shown in FIG. 6B;

FIG. 6D shows examples of paths through which the resource manager and the resource monitor shown in FIG. 6B may access stored data;

FIG. 6E is a block diagram of a resource delivery system similar to the shown in FIG. 6A but in which several elements are provided as a service within a cloud-based computing environment;

FIG. 7 depicts an illustrative virtualized (hypervisor) system architecture that may be used in accordance with one or more illustrative aspects described herein;

FIG. 8 is a block diagram illustrating example components of one or more computing systems, shown in FIG. 1A, for providing relevant information during an online meeting; and

FIGS. 9A and 9B show an example signal diagram according to an example implementation of the system shown in FIG. 8.

### DETAILED DESCRIPTION

A user can engage with other users via online meeting applications, which at a minimum allow users to have a speech-based conversation, and which may additionally allow users to view other users (via cameras), share screens, engage in chat messages, etc. Online meetings may also be referred to as virtual meetings. Users engaged in online meetings may experience a lack of information, especially information relevant to a topic being discussed during the online meeting. Users may spend time looking for relevant information during online meetings to learn about the topic being discussed. Moreover, users may search multiple data sources to find the relevant information. The inventors have recognized and appreciated that such searching may distract the user from the online meeting and may also waste the online meeting participants' time.

Offered are techniques for presenting relevant information to a user during an online meeting based on a topic of interest. For example, some techniques described herein involve determining a topic of interest during an online meeting, querying one or more data sources for information corresponding to the topic of interest, and presenting the relevant information to the user during the online meeting. In determining a topic of interest, techniques may involve speech-to-text processing and natural language processing (NLP). The queried data sources may include one or more applications or systems that the user has access to, such as intranet applications, email applications, file sharing systems, etc. One of the queried data sources may be the Internet (e.g., by performing a web search). The relevant information may be presented to the user via a client device that is being operated by the user to engage in the online meeting.

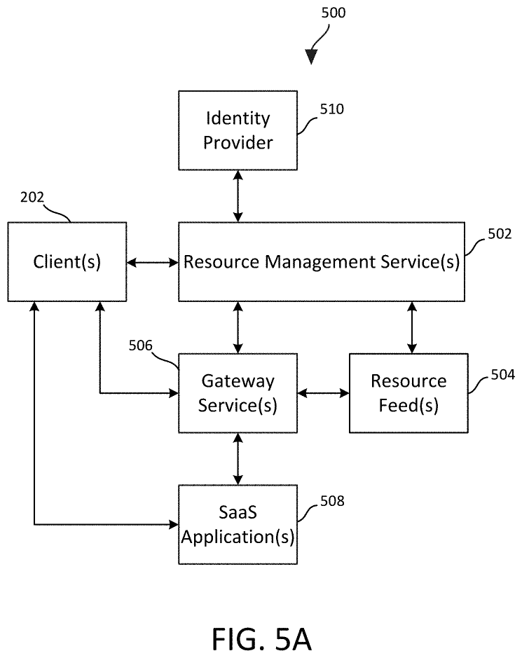

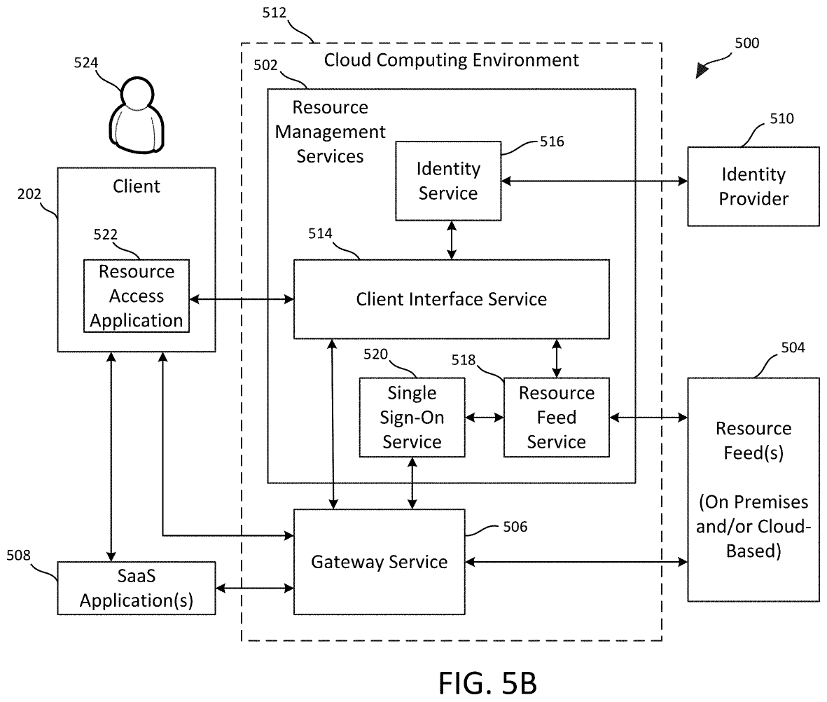

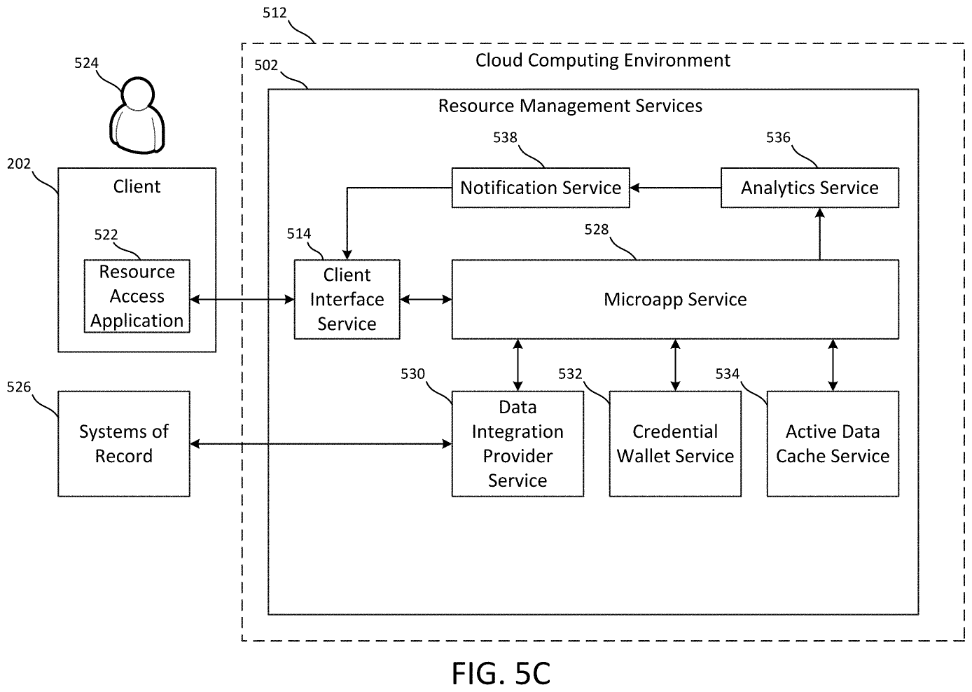

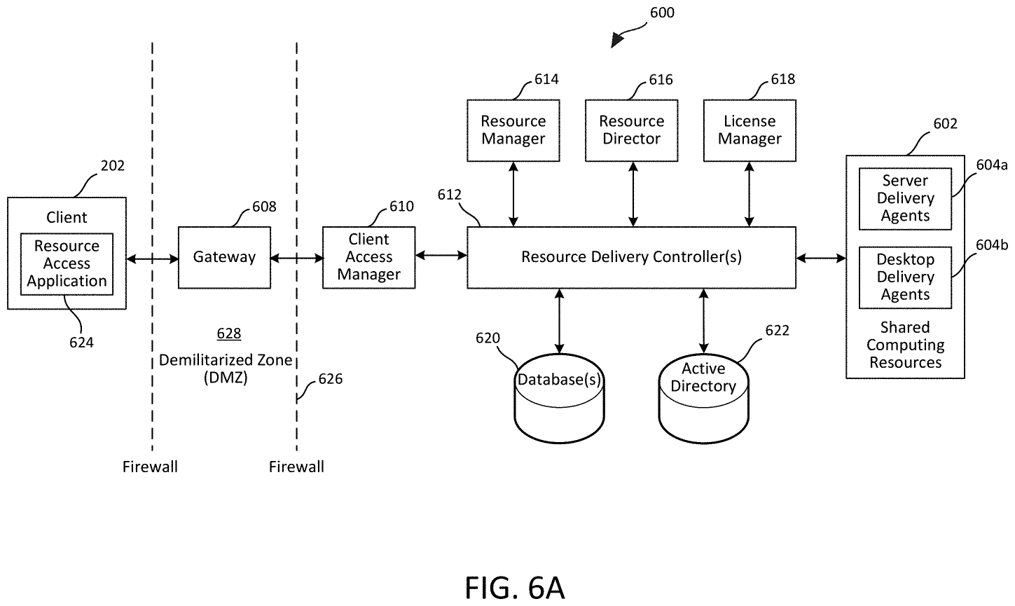

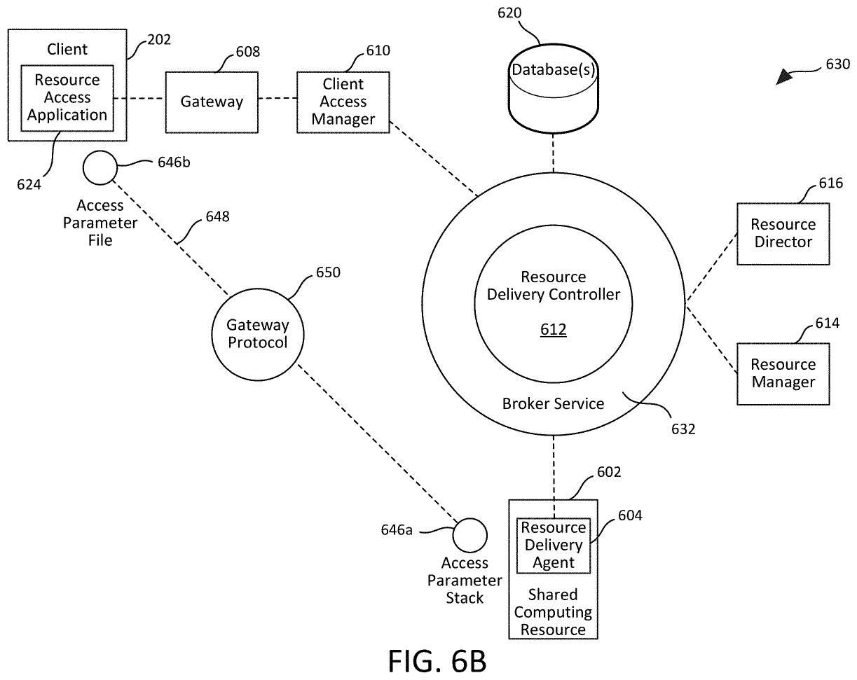

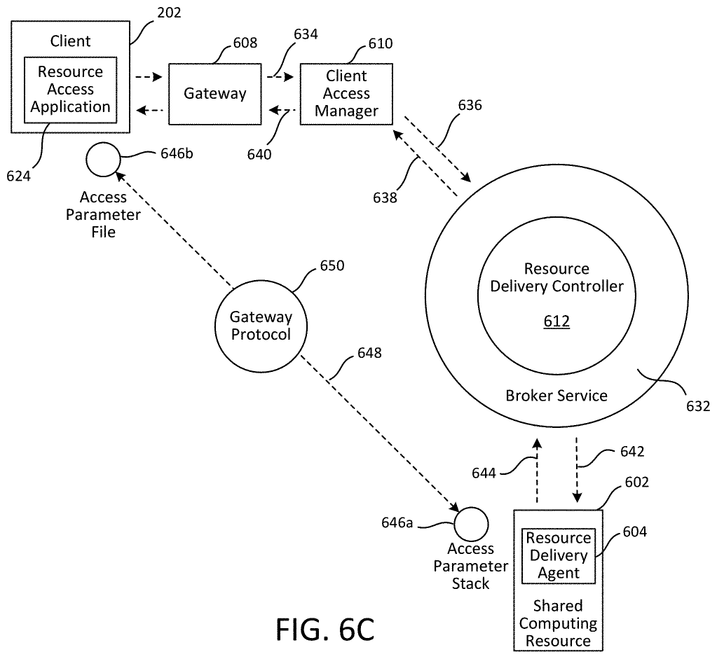

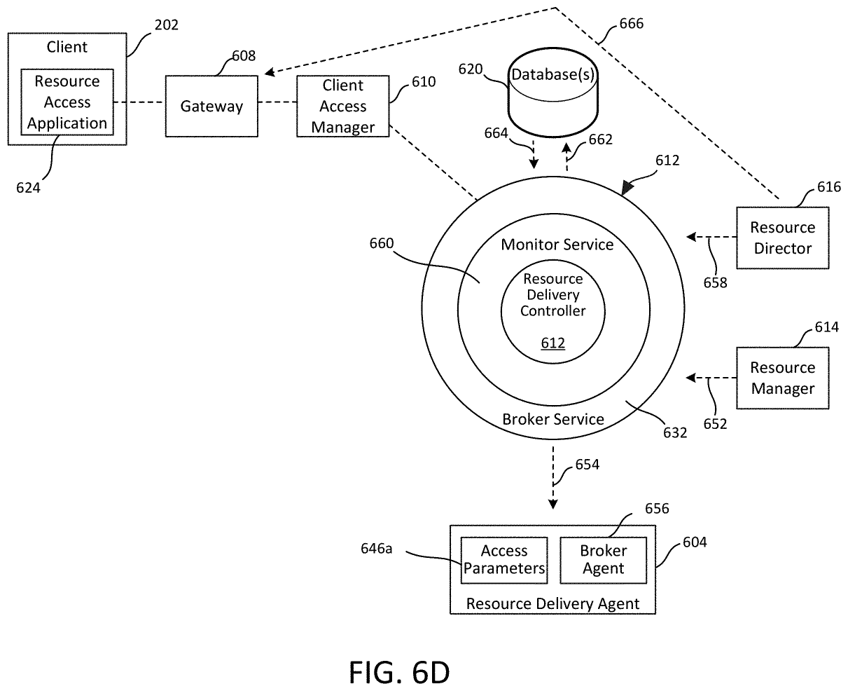

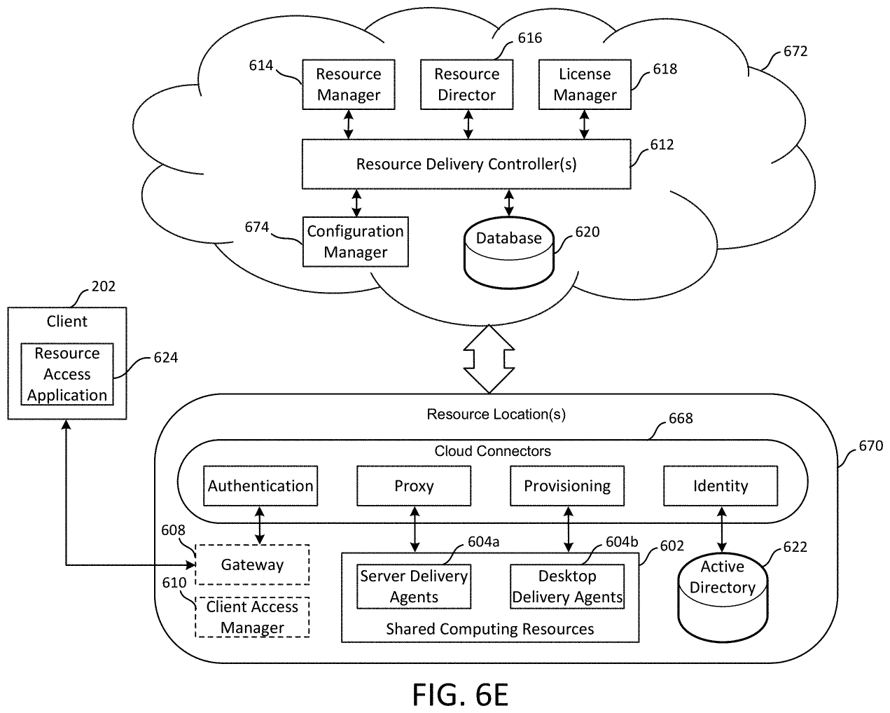

In some embodiments, the user may use a remote access technique to access (launch/open) a meeting application to engage in the online meeting. Such remote access techniques may be enabled, for example, by a multi-resource access system 500 (described below in relation to FIGS. 5A-5C in Section E) or by a resource delivery system 600 (described below in relation to FIG. 6A in Section F). In some implementations, using the multi-resource access system 500 or the resource delivery system 600, data sources accessible by the user may be queried for relevant information, and the relevant information may be presented via the meeting application or as an overlay to the meeting application at the user's client device.

For purposes of reading the description below of the various embodiments, the following descriptions of the sections of the specification and their respective contents may be helpful:

Section A provides an introduction to example embodiments of a system for providing relevant information during online meetings;

Section B describes a network environment which may be useful for practicing embodiments described herein;

Section C describes a computing system which may be useful for practicing embodiments described herein;

Section D describes embodiments of systems and methods for accessing computing resources using a cloud computing environment;

Section E describes embodiments of systems and methods for managing and streamlining access by clients to a variety of resources;

Section F describes an example implementation of a resource delivery system which may be useful for practicing embodiments described herein;

Section G describes an example architecture of a resource virtualization server;

Section H provides a more detailed description of example embodiments of the system for providing relevant information during online meetings introduced in Section A; and

Section I describes example implementations of methods, systems/devices, and computer-readable media in accordance with the present disclosure.

A. Introduction to Illustrative Embodiments of a System Providing Relevant Information during Online Meetings

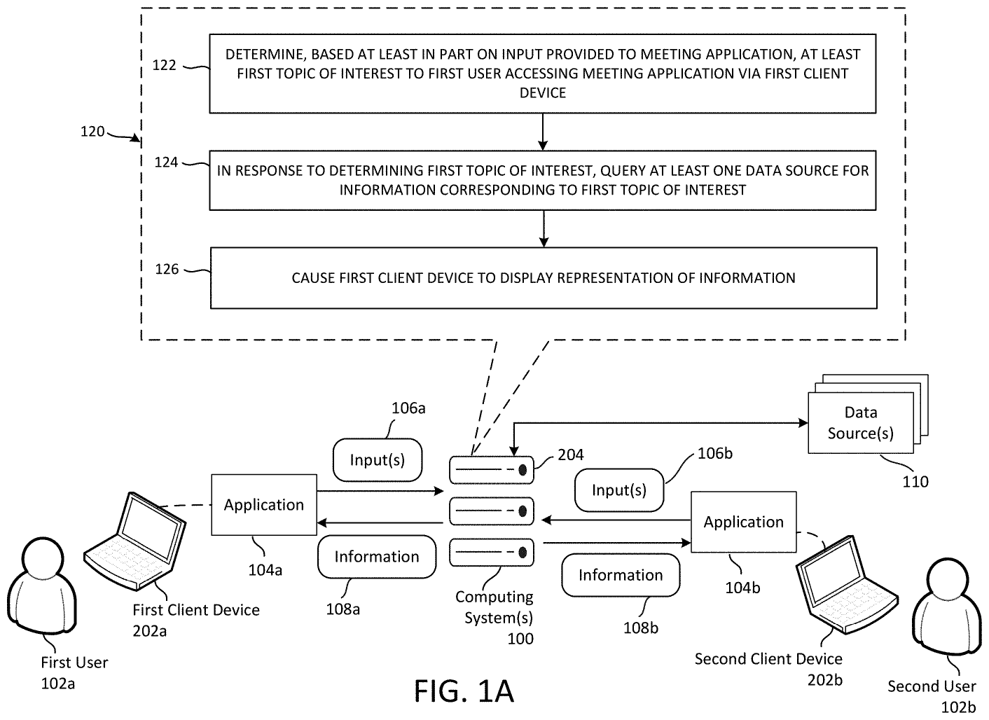

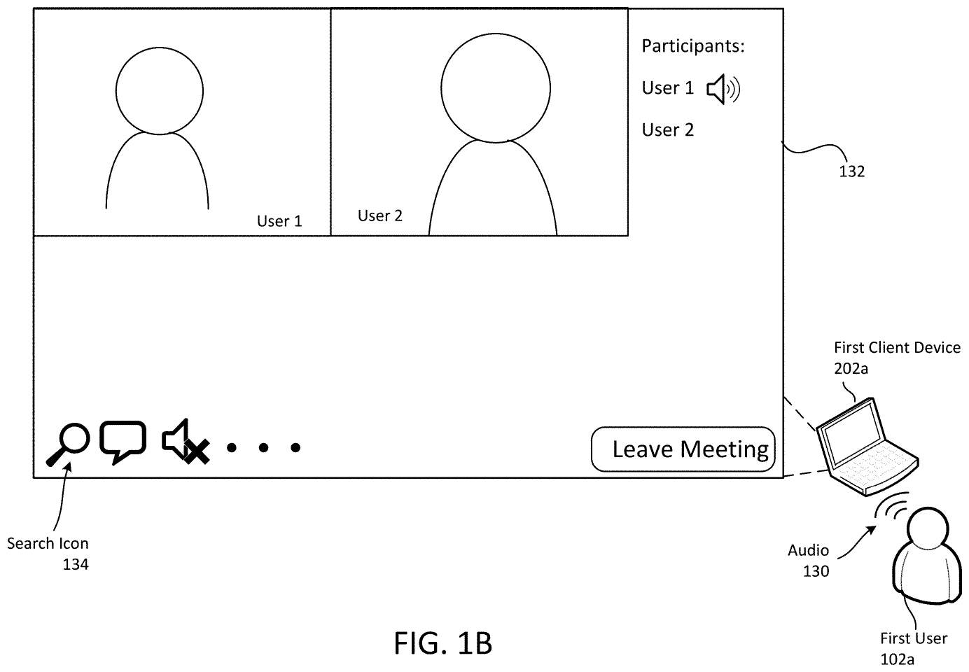

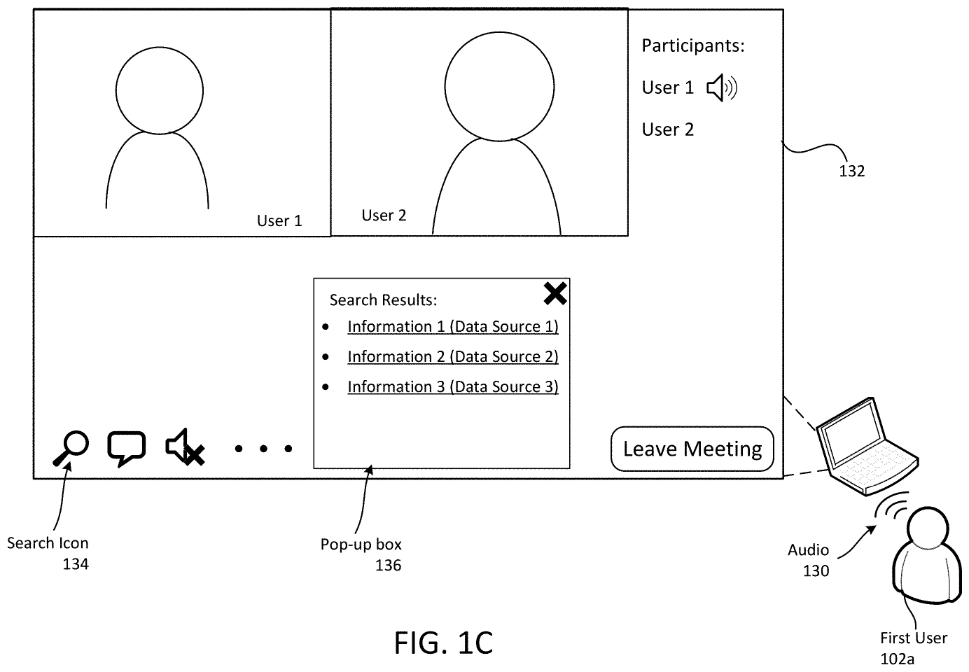

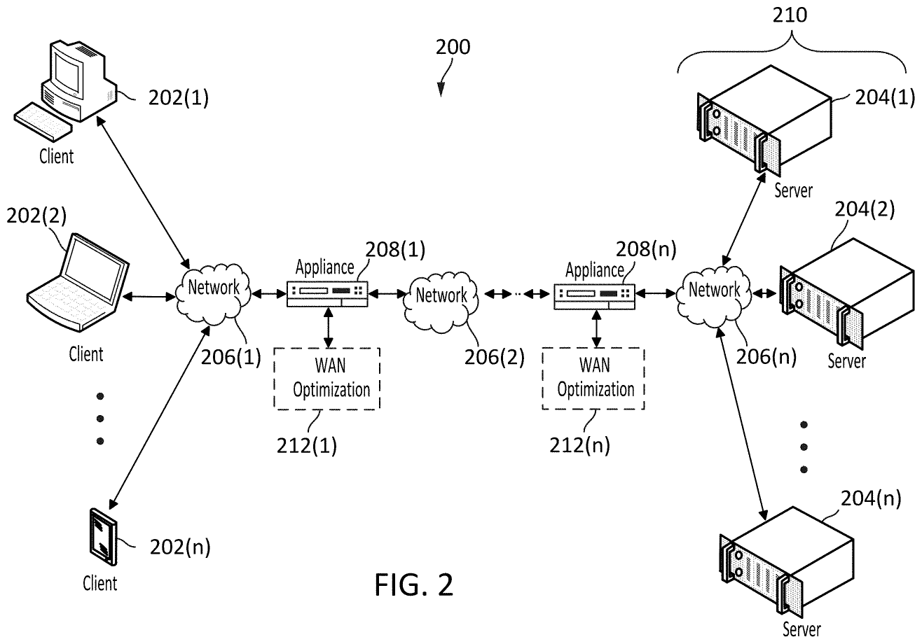

FIG. 1A shows an example configuration with which some aspects of the present disclosure may be implemented. As shown, one or more computing systems 100 may be in communication with one or more client devices 202 operated by respective users 102, and may also be in communication with one or more data sources 110. The client devices 202 may include respective applications 104, which may be configured to enable the users 102 to engage in an online meeting. The computing system(s) 100 may be implemented by one or more servers 204. Examples of components that may be used to implement the client device 202 and the servers 204, as well as examples of computing environments in which such components may be deployed, are described below in connection with FIGS. 2-4.

The example shown in FIG. 1A involves a first user 102a operating a first client device 202a to launch an application 104a to participate in an online meeting. A second user 102b may operate a second client device 202b to launch an application 104b to participate in the online meeting with the first user 102a. In some embodiments, the application 104 may be a meeting application, such as GoToMeeting, Microsoft Teams, ZOOM, Google Meet, Slack, etc.

In other embodiments, the application 104 may be a resource access application 522 of the multi-resource access system 500 shown in FIGS. 5B-BC and described below in Section E. A user 102 may, for example, access one or more SaaS applications 508, at the client device 202, using the user interface of the resource access application 522. In some implementations, one of the SaaS applications 508 accessed by the user 102 may be a meeting application that enables the user 102 to participate in online meetings. In such embodiments, the computing system(s) 100 may include one or more components of, and/or operate in conjunction with, the multi-resource access system 500 shown in FIGS. 5A-5C and described below in Section E.

In other embodiments, the application 104 may be a resource access application 624 of the resource delivery system 600 shown in FIGS. 6A-6E and described below in Section F. A user 102 may, for example, remotely access one or more desktops and/or virtual applications, at the client device 202, using the resource access application 624. The user 102 may open a meeting application within the resource access application 624 to participate in the online meeting, where the meeting application may running on one or more shared computing resources 602 shown in FIGS. 6A-6E. In such embodiments, the computing system(s) 100 may include one or more components of, and/or operate in conjunction with, the resource delivery system 600 shown in FIGS. 6A-6E and described below in Section F.

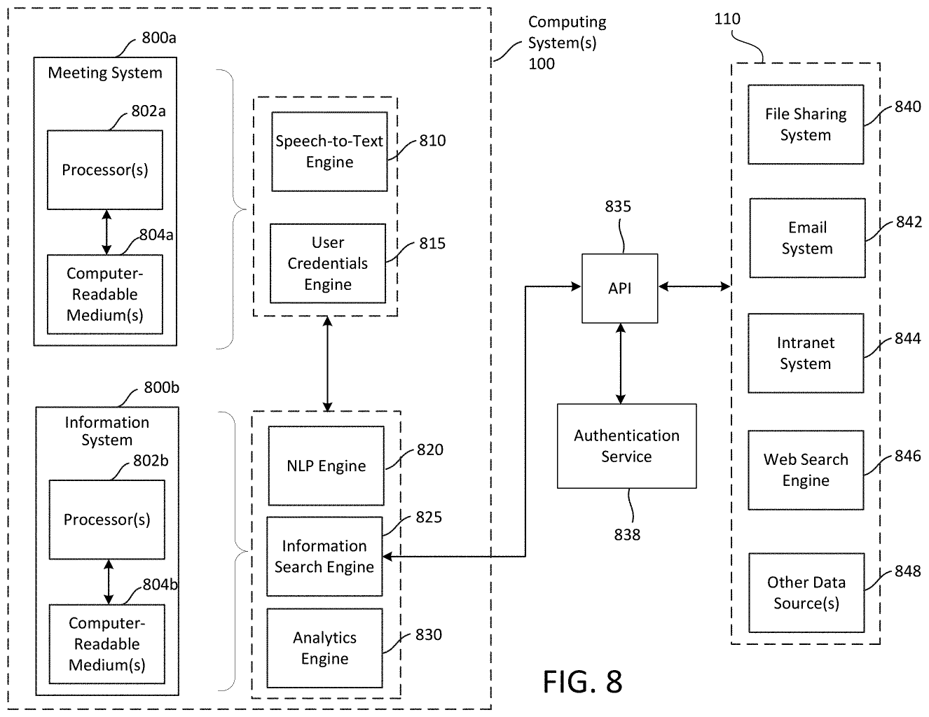

In some embodiments, the computing system(s) 100 may include a meeting system 800a and a separate information system 800b (shown in FIG. 8 and described below in Section H), where the meeting system 800a may be configured to provide online meeting capabilities, and the information system 800b may be configured to determine information relevant to a topic of interest. In other embodiments, one single computing system (e.g., a meeting system) may be configured to provide online capabilities and determine information relevant to a topic of interest. In such embodiments, the functionality of providing relevant information may be built into the meeting application/system.

In some implementations, the computing system(s) 100 may perform a process 120 shown in FIG. 1A. In participating in the online meeting, the first user 102a may provide one or more inputs to the application 104a. Such input(s) may include speech from the first user 102a. For example, the first user 102a may speak to the second user 102b or other users participating in the online meeting. The speech from the first user 102a may be captured by one or more microphones of the first client device 202a in the form of audio. The input(s) may additionally or alternatively include mouse clicks, keyword inputs, video captured by one or more cameras of the first client device 202a (e.g., video of the first user 102a), video captured by the application 104a of a screen shared by the first user 102a, audio shared by the first user 102a (e.g., the first user 102a may play music during the online meeting), and/or other types of input. The application 104a may send data corresponding to captured input(s) 106a to the computing system 100. For example, the application 104a may send audio data corresponding to speech from the first user 102a, video data corresponding to the screen shared by the first user 102a, etc.

In some embodiments, the application 104a may enable the first user 102a to initiate a search using one or more keywords during the online meeting, for example, using a search icon 134 shown in FIG. 1B. For example, the first user 102a may click on the search icon 134 and may enter one or more keywords (using a keyboard of the first client device 202a), and in turn, the application 104a may send data corresponding to the entered inputs 106a (keywords) to the computing system(s) 100.

At a step 122 of the process 120, the computing system(s) 100 may determine, based at least in part on the input(s) 106a provided to the meeting application 104a, at least a first topic of interest to the first user 102a accessing the meeting application 104a via the first client device 202a. In the case that the input(s) 106a is audio data corresponding to speech from the first user 102a, the computing system(s) 100 may determine the first topic using the audio data. For example, in some implementations, the computing system(s) 100 may use speech-to-text processing to convert the audio data/input(s) 106 to text data, then use NLP techniques to determine the first topic from the text data. As such, the first topic may correspond to what the first user 102a is speaking about. In the case that the input(s) 106a is one or more keywords entered by the first user 102a via the search icon 134, the computing system(s) 100 may determine the first topic based on the entered keyword(s). In the case that the input(s) 106a is another type of input described above, the computing system(s) 100 may use other techniques to determine the first topic from the input(s) 106a. In some implementations, the computing system(s) 100 may determine the first topic based on a combination of speech inputs and keyword inputs received from the first user 102a.

At a step 124 of the process 120, the computing system(s) 100, in response to determining the first topic of interest, may query at least one data source 110 for information corresponding to the first topic of interest. In some implementations, the data sources 110 may include, but are not limited to, a file sharing system, an intranet system, an email system, a messaging system, and/or a web search engine. The computing system(s) 100 may determine which data sources 110 the first user 102a is authorized to access. In some implementations, the computing system(s) 100 may access one or more of the data sources 110 using user credentials for the first user 102a. In accessing the data source(s) 110 using the first user's 102a credentials, the computing system(s) 100 may be able to find information that is accessible and pertinent to the first user 102a. For example, the computing system(s) 100 may query a file sharing system, accessible by the first user 102a, and may retrieve one or more files corresponding to the first topic. As another example, the computing system(s) 100 may query an intranet system accessible by the first user 102a, and may retrieve links or other types of information corresponding to the first topic. As yet another example, the computing system(s) 100 may query an email system accessible by the first user 102a, and may retrieve one or more emails corresponding to the first topic. In some implementations, the computing system(s) 100 may perform a web search (e.g., using a search engine such as Google, Bing, etc.) for information corresponding to the first topic of interest.

In some embodiments, such as where the first user 102a participates in the online meeting via a meeting application that is accessed using the resource access application 522, one or more of the data sources 110 may be the SaaS applications 508 that the first user 102a is authorized to access.

In some embodiments, such as where the first user 102a participates in the online meeting via a meeting application that is accessed using the resource access application 624, one or more of the data sources 110 may be resources hosted at the shared computing resources 602 that the first user 102a is authorized to access.

Based on querying the data source(s) 110, the computing system(s) 100 may receive multiple search results corresponding to the first topic. In some embodiments, the computing system(s) 100 may filter, prune, rank and/or perform other type of processing on the received search results to determine which search results are to be presented to the first user 102a.

The information 108a may, for example, include one or more files from a file sharing system, information from an intranet system, one or more emails from an email system, one or more messages/conversations from a messaging system, and/or one or more web search results. In some implementations, the computing system(s) 100 may determine a representation of the information 108a, where the representation may be a title of the information 108a and/or a summary of the information 108a. The computing system(s) 100 may determine the title and/or summary based on the type of information. For example, if the information 108a includes a file, then the title may be the file name, and the summary may be based on the contents of the file, files tags or a description of the file, if available. As another example, if the information 108a includes an email, then the title may be the subject line of the email, and the summary may be based on the contents of the email. As yet another example, if the information 108a includes a web search result, then the title may be the name of the webpage, and the summary may be the summary provided by the web search engine. In some implementations, the computing system(s) 100 may also include the name of the data source 110, from which the information 108a is retrieved, in the representation of the information 108a.

At a step 126 of the process 120, the computing system(s) 100 may cause the first client device 202a to display the representation of information 108a. As shown in FIG. 1A, the computing system(s) 100 may send the representation of the information 108a to the first client device 202a for display. In some implementations, the representation of the information 108a may be presented as a selectable user interface element, such as a hyperlink, a button, etc. Selection (e.g., clicking using a mouse, selecting via a touch input, etc.) of the user interface element may enable the first user 102a to access the corresponding information 108a at the first client device 202a. For example, if the information 108a includes a file, then selecting the corresponding user interface element may open the file or may open a folder in the file sharing system where the file can be accessed by the first user 102a.

In some implementations, the representation of the information 108a may be displayed via the application 104a. FIG. 1C shows a user interface screen 132 where the representation of the information 108a is presented in the meeting application via a pop-up box 136. In other implementations, the representation of the information 108a may be displayed at the first client device 202a as a separate user interface screen from the meeting application user interface screen (e.g., an overlay on the meeting application user interface screen).

FIG. 1B shows a user interface screen 132 of a meeting application (e.g., the application 104a) being accessed by the first user 102a at the first client device 202a to participate in an online meeting. As shown, the user interface screen 132 may include a video/image representation the participants of the online meeting, for example, User 1, which may be the first user 102a, and User 2, which may be the second user 102b. The user interface screen 132 may also include one or more icons, buttons, and other interface elements enabling the first user 102a to provide inputs during the online meeting. For example, the user interface screen 132 may include the search icon 134, using which the first user 102a may enter one or more keywords to search for information as described above. The first user 102a may provide speech inputs during the online meeting, which may be captured by the first client device 202a as audio 130. As described above, the audio 130 may be converted to text data, and used to determine the first topic of interest to the first user 102a.

FIG. 1C shows the user interface screen 132, of the meeting application being accessed by the first user 102a at the first client device 202a, which includes the pop-up box 136 displaying search results for the first topic of interest to the first user 102a. In some implementations, the pop-up box 136 may be displayed automatically when the computing system(s) 100 have sent the representation of the information 108a to the first client device 202a. In some implementations, for example, the first user 102a may have previously enabled a feature within the application 104a that allows for automatic searching for relevant information during an online meeting. Based on this feature being enabled, the pop-up box 136 may be presented automatically. In other implementations, the first user 102a may provide an input requesting display of the pop-up box 136, for example, by selecting the search icon 134 or another icon within the user interface screen 132.

The computing system(s) 100 may provide relevant information to the second user 102b based on a second topic of interest to the second user 102b. In a similar manner described above in relation to the process 120, the computing system(s) 100 may determine a second topic of interest to the second user 102b based on input(s) 106b provided by the second user 102b to the application 104b. For example, the input(s) 106b may be audio corresponding to speech provided by the second user 102b. Based on the second topic of interest, the computing system(s) 100 may query at least one data source 110 for information corresponding to the second topic of interest, where the data source 110 may be accessible by the second user 102b, and may retrieve information that is accessible and pertinent to the second user 102b. The computing system(s) 100 may cause the second client device 202b to display a representation of the information 108b, in a similar manner as described in relation to FIG. 1C. In this manner, the computing system(s) 100 may provide information relevant to the individual users 102 to the respective client devices 202.

Additionally, in some implementations, the computing system(s) 100 may automatically provide updated information as a topic of interest changes during the online meeting. The computing system(s) 100 may determine at least one updated topic of interest based on ongoing input(s) 106 provided by the user 102 at a (second) time subsequent to a first time when previous inputs were provided by the user 102 using which the first topic was determined. For example, the user 102 may continue speaking during the online meeting, and the computing system 100 may use the speech input(s) 106 to determine the updated topic. In response to determining the updated topic, the computing system(s) 100 may query at least one data source 110 for information corresponding to the updated topic, and may cause the client device 202 to display a representation of the information 108 corresponding to the updated topic. In some implementations, the pop-up box 136 shown in FIG. 1C may be updated to display search results corresponding to the updated topic. Thus, as the conversation is on-going during the online meeting, the user 102 may be able to see updated search results based on the on-going conversation. The updated search results may be presented, for example, as rolling search results in the pop-up box 136 as the conversation during the online meeting continues. In some implementations, the updated search results may be based on the transcript of the on-going online meeting as the transcript is generated by the meeting application 104. The search results may thus be updated in the pop-up box 136 without input/intervention from the user 102 other than the user's voice during the meeting.

Additional details and example implementations of embodiments of the present disclosure are set forth below in Section H, following a description of example systems and network environments in which such embodiments may be deployed.

B. Network Environment

Referring to FIG. 2, an illustrative network environment 200 is depicted. As shown, the network environment 200 may include one or more clients 202(1)-202(n) (also generally referred to as local machine(s) 202 or client(s) 202) in communication with one or more servers 204(1)-204(n) (also generally referred to as remote machine(s) 204 or server(s) 204) via one or more networks 206(1)-206(n) (generally referred to as network(s) 206). In some embodiments, a client 202 may communicate with a server 204 via one or more appliances 208(1)-208(n) (generally referred to as appliance(s) 208 or gateway(s) 208). In some embodiments, a client 202 may have the capacity to function as both a client node seeking access to resources provided by a server 204 and as a server 204 providing access to hosted resources for other clients 202.

Although the embodiment shown in FIG. 2 shows one or more networks 206 between the clients 202 and the servers 204, in other embodiments, the clients 202 and the servers 204 may be on the same network 206. When multiple networks 206 are employed, the various networks 206 may be the same type of network or different types of networks. For example, in some embodiments, the networks 206(1) and 206(n) may be private networks such as local area network (LANs) or company Intranets, while the network 206(2) may be a public network, such as a metropolitan area network (MAN), wide area network (WAN), or the Internet. In other embodiments, one or both of the network 206(1) and the network 206(n), as well as the network 206(2), may be public networks. In yet other embodiments, all three of the network 206(1), the network 206(2) and the network 206(n) may be private networks. The networks 206 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols. In some embodiments, the network(s) 206 may include one or more mobile telephone networks that use various protocols to communicate among mobile devices. In some embodiments, the network(s) 206 may include one or more wireless local-area networks (WLANs). For short range communications within a WLAN, clients 202 may communicate using 802.11, Bluetooth, and/or Near Field Communication (NFC).

As shown in FIG. 2, one or more appliances 208 may be located at various points or in various communication paths of the network environment 200. For example, the appliance 208(1) may be deployed between the network 206(1) and the network 206(2), and the appliance 208(n) may be deployed between the network 206(2) and the network 206(n). In some embodiments, the appliances 208 may communicate with one another and work in conjunction to, for example, accelerate network traffic between the clients 202 and the servers 204. In some embodiments, appliances 208 may act as a gateway between two or more networks. In other embodiments, one or more of the appliances 208 may instead be implemented in conjunction with or as part of a single one of the clients 202 or servers 204 to allow such device to connect directly to one of the networks 206. In some embodiments, one of more appliances 208 may operate as an application delivery controller (ADC) to provide one or more of the clients 202 with access to business applications and other data deployed in a datacenter, the cloud, or delivered as Software as a Service (SaaS) across a range of client devices, and/or provide other functionality such as load balancing, etc. In some embodiments, one or more of the appliances 208 may be implemented as network devices sold by Citrix Systems, Inc., of Fort Lauderdale, Fla., such as Citrix Gateway™ or Citrix ADC™.

A server 204 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 204 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 204 may execute a remote presentation services program or other program that uses a thin-client or a remote-display protocol to capture display output generated by an application executing on a server 204 and transmit the application display output to a client device 202.

In yet other embodiments, a server 204 may execute a virtual machine providing, to a user of a client 202, access to a computing environment. The client 202 may be a virtual machine. The virtual machine may be managed by, for example, a hypervisor, a virtual machine manager (VMM), or any other hardware virtualization technique within the server 204.

As shown in FIG. 2, in some embodiments, groups of the servers 204 may operate as one or more server farms 210. The servers 204 of such server farms 210 may be logically grouped, and may either be geographically co-located (e.g., on premises) or geographically dispersed (e.g., cloud based) from the clients 202 and/or other servers 204. In some embodiments, two or more server farms 210 may communicate with one another, e.g., via respective appliances 208 connected to the network 206(2), to allow multiple server-based processes to interact with one another.

As also shown in FIG. 2, in some embodiments, one or more of the appliances 208 may include, be replaced by, or be in communication with, one or more additional appliances, such as WAN optimization appliances 212(1)-212(n), referred to generally as WAN optimization appliance(s) 212. For example, WAN optimization appliances 212 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, one or more of the appliances 212 may be a performance enhancing proxy or a WAN optimization controller.

In some embodiments, one or more of the appliances 208, 212 may be implemented as products sold by Citrix Systems, Inc., of Fort Lauderdale, Fla., such as Citrix SD-WAN™ or Citrix Cloud™. For example, in some implementations, one or more of the appliances 208, 212 may be cloud connectors that enable communications to be exchanged between resources within a cloud computing environment and resources outside such an environment, e.g., resources hosted within a data center of+an organization.

C. Computing Environment

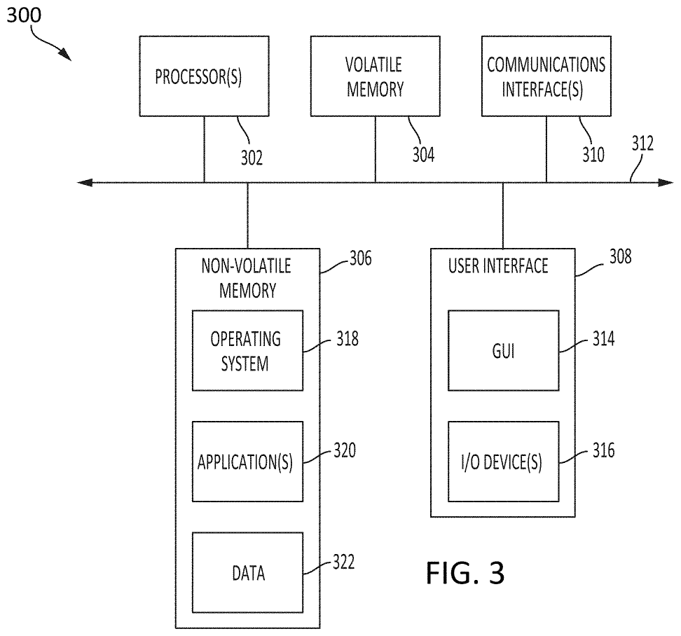

FIG. 3 illustrates an example of a computing system 300 that may be used to implement one or more of the respective components (e.g., the clients 202, the servers 204, the appliances 208, 212) within the network environment 200 shown in FIG. 2. As shown in FIG. 3, the computing system 300 may include one or more processors 302, volatile memory 304 (e.g., RAM), non-volatile memory 306 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 308, one or more communications interfaces 310, and a communication bus 312. The user interface 308 may include a graphical user interface (GUI) 314 (e.g., a touchscreen, a display, etc.) and one or more input/output (I/O) devices 316 (e.g., a mouse, a keyboard, etc.). The non-volatile memory 306 may store an operating system 318, one or more applications 320, and data 322 such that, for example, computer instructions of the operating system 318 and/or applications 320 are executed by the processor(s) 302 out of the volatile memory 304. Data may be entered using an input device of the GUI 314 or received from I/O device(s) 316. Various elements of the computing system 300 may communicate via communication the bus 312. The computing system 300 as shown in FIG. 3 is shown merely as an example, as the clients 202, servers 204 and/or appliances 208 and 212 may be implemented by any computing or processing environment and with any type of machine or set of machines that may have suitable hardware and/or software capable of operating as described herein.

The processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

The communications interfaces 310 may include one or more interfaces to enable the computing system 300 to access a computer network such as a Local Area Network (LAN), a Wide Area Network (WAN), a Personal Area Network (PAN), or the Internet through a variety of wired and/or wireless connections, including cellular connections.

As noted above, in some embodiments, one or more computing systems 300 may execute an application on behalf of a user of a client computing device (e.g., a client 202 shown in FIG. 2), may execute a virtual machine, which provides an execution session within which applications execute on behalf of a user or a client computing device (e.g., a client 202 shown in FIG. 2), such as a hosted desktop session, may execute a terminal services session to provide a hosted desktop environment, or may provide access to a computing environment including one or more of: one or more applications, one or more desktop applications, and one or more desktop sessions in which one or more applications may execute.

D. Systems and Methods for Delivering Shared Resources Using a Cloud Computing Environment

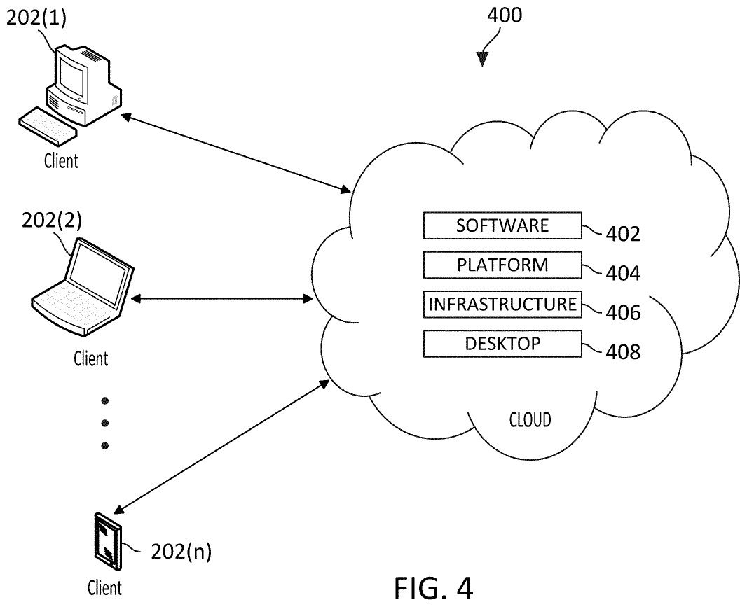

Referring to FIG. 4, a cloud computing environment 400 is depicted, which may also be referred to as a cloud environment, cloud computing or cloud network. The cloud computing environment 400 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 400, one or more clients 202 (such as those described in connection with FIG. 2) are in communication with a cloud network 404. The cloud network 404 may include back-end platforms, e.g., servers, storage, server farms and/or data centers. The clients 202 may correspond to a single organization/tenant or multiple organizations/tenants. More particularly, in one example implementation, the cloud computing environment 400 may provide a private cloud serving a single organization (e.g., enterprise cloud). In another example, the cloud computing environment 400 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 400 may provide a hybrid cloud that is a combination of a public cloud and one or more resources located outside such a cloud, such as resources hosted within one or more data centers of an organization. Public clouds may include public servers that are maintained by third parties to the clients 202 or the enterprise/tenant. The servers may be located off-site in remote geographical locations or otherwise. In some implementations, one or more cloud connectors may be used to facilitate the exchange of communications between one more resources within the cloud computing environment 400 and one or more resources outside of such an environment.

The cloud computing environment 400 can provide resource pooling to serve multiple users via clients 202 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 400 can provide on-demand self-service to unilaterally provision computing capabilities (e.g., server time, network storage) across a network for multiple clients 202. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 400 can provide an elasticity to dynamically scale out or scale in response to different demands from one or more clients 202. In some embodiments, the cloud computing environment 400 may include or provide monitoring services to monitor, control and/or generate reports corresponding to the provided shared services and resources.

In some embodiments, the cloud computing environment 400 may provide cloud-based delivery of different types of cloud computing services, such as Software as a service (SaaS) 402, Platform as a Service (PaaS) 404, Infrastructure as a Service (IaaS) 406, and Desktop as a Service (DaaS) 408, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure, such as AZURE CLOUD from Microsoft Corporation of Redmond, Wash., or AMAZON WEB SERVICES provided by Amazon.com, Inc., of Seattle, Wash., for example. In the case of Citrix Cloud, Citrix Workspace app may be used as a single-entry point for bringing apps, files and desktops together (whether on-premises or in the cloud) to deliver a unified experience.

E. Systems and Methods for Managing and Streamlining Access by Client Devices to a Variety of Resources

FIG. 5A is a block diagram of an example multi-resource access system 500 in which one or more resource management services 502 may manage and streamline access by one or more clients 202 to one or more resource feeds 504 (via one or more gateway services 506) and/or one or more software-as-a-service (SaaS) applications 508. In particular, the resource management service(s) 502 may employ an identity provider 510 to authenticate the identity of a user of a client 202 and, following authentication, identify one or more resources the user is authorized to access. In response to the user selecting one of the identified resources, the resource management service(s) 502 may send appropriate access credentials to the requesting client 202, and the client 202 may then use those credentials to access the selected resource. For the resource feed(s) 504, the client 202 may use the supplied credentials to access the selected resource via a gateway service 506. For the SaaS application(s) 508, the client 202 may use the credentials to access the selected application directly.

The client(s) 202 may be any type of computing devices capable of accessing the resource feed(s) 504 and/or the SaaS application(s) 508, and may, for example, include a variety of desktop or laptop computers, smartphones, tablets, etc. The resource feed(s) 504 may include any of numerous resource types and may be provided from any of numerous locations. In some embodiments, for example, the resource feed(s) 504 may include one or more systems or services for providing virtual applications and/or desktops to the client(s) 202, one or more file repositories and/or file sharing systems, one or more secure browser services, one or more access control services for the SaaS applications 508, one or more management services for local applications on the client(s) 202, one or more internet enabled devices or sensors, etc. The resource management service(s) 502, the resource feed(s) 504, the gateway service(s) 506, the SaaS application(s) 508, and the identity provider 510 may be located within an on-premises data center of an organization for which the multi-resource access system 500 is deployed, within one or more cloud computing environments, or elsewhere.

FIG. 5B is a block diagram showing an example implementation of the multi-resource access system 500 shown in FIG. 5A in which various resource management services 502 as well as a gateway service 506 are located within a cloud computing environment 512. The cloud computing environment may, for example, include Microsoft Azure Cloud, Amazon Web Services, Google Cloud, or IBM Cloud. It should be appreciated, however, that in other implementations, one or more (or all) of the components of the resource management services 502 and/or the gateway service 506 may alternatively be located outside the cloud computing environment 512, such as within a data center hosted by an organization.

For any of the illustrated components (other than the client 202) that are not based within the cloud computing environment 512, cloud connectors (not shown in FIG. 5B) may be used to interface those components with the cloud computing environment 512. Such cloud connectors may, for example, run on Windows Server instances and/or Linux Server instances hosted in resource locations and may create a reverse proxy to route traffic between those resource locations and the cloud computing environment 512. In the illustrated example, the cloud-based resource management services 502 include a client interface service 514, an identity service 516, a resource feed service 518, and a single sign-on service 520. As shown, in some embodiments, the client 202 may use a resource access application 522 to communicate with the client interface service 514 as well as to present a user interface on the client 202 that a user 524 can operate to access the resource feed(s) 504 and/or the SaaS application(s) 508. The resource access application 522 may either be installed on the client 202, or may be executed by the client interface service 514 (or elsewhere in the multi-resource access system 500) and accessed using a web browser (not shown in FIG. 5B) on the client 202.

As explained in more detail below, in some embodiments, the resource access application 522 and associated components may provide the user 524 with a personalized, all-in-one interface enabling instant and seamless access to all the user's SaaS and web applications, files, virtual Windows applications, virtual Linux applications, desktops, mobile applications, Citrix Virtual Apps and Desktops™, local applications, and other data.

When the resource access application 522 is launched or otherwise accessed by the user 524, the client interface service 514 may send a sign-on request to the identity service 516. In some embodiments, the identity provider 510 may be located on the premises of the organization for which the multi-resource access system 500 is deployed. The identity provider 510 may, for example, correspond to an on-premises Windows Active Directory. In such embodiments, the identity provider 510 may be connected to the cloud-based identity service 516 using a cloud connector (not shown in FIG. 5B), as described above. Upon receiving a sign-on request, the identity service 516 may cause the resource access application 522 (via the client interface service 514) to prompt the user 524 for the user's authentication credentials (e.g., username and password). Upon receiving the user's authentication credentials, the client interface service 514 may pass the credentials along to the identity service 516, and the identity service 516 may, in turn, forward them to the identity provider 510 for authentication, for example, by comparing them against an Active Directory domain. Once the identity service 516 receives confirmation from the identity provider 510 that the user's identity has been properly authenticated, the client interface service 514 may send a request to the resource feed service 518 for a list of subscribed resources for the user 524.

In other embodiments (not illustrated in FIG. 5B), the identity provider 510 may be a cloud-based identity service, such as a Microsoft Azure Active Directory. In such embodiments, upon receiving a sign-on request from the client interface service 514, the identity service 516 may, via the client interface service 514, cause the client 202 to be redirected to the cloud-based identity service to complete an authentication process. The cloud-based identity service may then cause the client 202 to prompt the user 524 to enter the user's authentication credentials. Upon determining the user's identity has been properly authenticated, the cloud-based identity service may send a message to the resource access application 522 indicating the authentication attempt was successful, and the resource access application 522 may then inform the client interface service 514 of the successfully authentication. Once the identity service 516 receives confirmation from the client interface service 514 that the user's identity has been properly authenticated, the client interface service 514 may send a request to the resource feed service 518 for a list of subscribed resources for the user 524.

The resource feed service 518 may request identity tokens for configured resources from the single sign-on service 520. The resource feed service 518 may then pass the feed-specific identity tokens it receives to the points of authentication for the respective resource feeds 504. The resource feeds 504 may then respond with lists of resources configured for the respective identities. The resource feed service 518 may then aggregate all items from the different feeds and forward them to the client interface service 514, which may cause the resource access application 522 to present a list of available resources on a user interface of the client 202. The list of available resources may, for example, be presented on the user interface of the client 202 as a set of selectable icons or other elements corresponding to accessible resources. The resources so identified may, for example, include one or more virtual applications and/or desktops (e.g., Citrix Virtual Apps and Desktops™, VMware Horizon, Microsoft RDS, etc.), one or more file repositories and/or file sharing systems (e.g., Sharefile®, one or more secure browsers, one or more internet enabled devices or sensors, one or more local applications installed on the client 202, and/or one or more SaaS applications 508 to which the user 524 has subscribed. The lists of local applications and the SaaS applications 508 may, for example, be supplied by resource feeds 504 for respective services that manage which such applications are to be made available to the user 524 via the resource access application 522. Examples of SaaS applications 508 that may be managed and accessed as described herein include Microsoft Office 365 applications, SAP SaaS applications, Workday applications, etc.

For resources other than local applications and the SaaS application(s) 508, upon the user 524 selecting one of the listed available resources, the resource access application 522 may cause the client interface service 514 to forward a request for the specified resource to the resource feed service 518. In response to receiving such a request, the resource feed service 518 may request an identity token for the corresponding feed from the single sign-on service 520. The resource feed service 518 may then pass the identity token received from the single sign-on service 520 to the client interface service 514 where a launch ticket for the resource may be generated and sent to the resource access application 522. Upon receiving the launch ticket, the resource access application 522 may initiate a secure session to the gateway service 506 and present the launch ticket. When the gateway service 506 is presented with the launch ticket, it may initiate a secure session to the appropriate resource feed and present the identity token to that feed to seamlessly authenticate the user 524. Once the session initializes, the client 202 may proceed to access the selected resource.

When the user 524 selects a local application, the resource access application 522 may cause the selected local application to launch on the client 202. When the user 524 selects a SaaS application 508, the resource access application 522 may cause the client interface service 514 to request a one-time uniform resource locator (URL) from the gateway service 506 as well a preferred browser for use in accessing the SaaS application 508. After the gateway service 506 returns the one-time URL and identifies the preferred browser, the client interface service 514 may pass that information along to the resource access application 522. The client 202 may then launch the identified browser and initiate a connection to the gateway service 506. The gateway service 506 may then request an assertion from the single sign-on service 520. Upon receiving the assertion, the gateway service 506 may cause the identified browser on the client 202 to be redirected to the logon page for identified SaaS application 508 and present the assertion. The SaaS may then contact the gateway service 506 to validate the assertion and authenticate the user 524. Once the user has been authenticated, communication may occur directly between the identified browser and the selected SaaS application 508, thus allowing the user 524 to use the client 202 to access the selected SaaS application 508.

In some embodiments, the preferred browser identified by the gateway service 506 may be a specialized browser embedded in the resource access application 522 (when the resource application is installed on the client 202) or provided by one of the resource feeds 504 (when the resource access application 522 is located remotely), e.g., via a secure browser service. In such embodiments, the SaaS applications 508 may incorporate enhanced security policies to enforce one or more restrictions on the embedded browser. Examples of such policies include (1) requiring use of the specialized browser and disabling use of other local browsers, (2) restricting clipboard access, e.g., by disabling cut/copy/paste operations between the application and the clipboard, (3) restricting printing, e.g., by disabling the ability to print from within the browser, (3) restricting navigation, e.g., by disabling the next and/or back browser buttons, (4) restricting downloads, e.g., by disabling the ability to download from within the SaaS application, and (5) displaying watermarks, e.g., by overlaying a screen-based watermark showing the username and IP address associated with the client 202 such that the watermark will appear as displayed on the screen if the user tries to print or take a screenshot. Further, in some embodiments, when a user selects a hyperlink within a SaaS application, the specialized browser may send the URL for the link to an access control service (e.g., implemented as one of the resource feed(s) 504) for assessment of its security risk by a web filtering service. For approved URLs, the specialized browser may be permitted to access the link. For suspicious links, however, the web filtering service may have the client interface service 514 send the link to a secure browser service, which may start a new virtual browser session with the client 202, and thus allow the user to access the potentially harmful linked content in a safe environment.

In some embodiments, in addition to or in lieu of providing the user 524 with a list of resources that are available to be accessed individually, as described above, the user 524 may instead be permitted to choose to access a streamlined feed of event notifications and/or available actions that may be taken with respect to events that are automatically detected with respect to one or more of the resources. This streamlined resource activity feed, which may be customized for individual users, may allow users to monitor important activity involving all of their resources—SaaS applications, web applications, Windows applications, Linux applications, desktops, file repositories and/or file sharing systems, and other data through a single interface, without needing to switch context from one resource to another. Further, event notifications in a resource activity feed may be accompanied by a discrete set of user interface elements, e.g., “approve,” “deny,” and “see more detail” buttons, allowing a user to take one or more simple actions with respect to events right within the user's feed. In some embodiments, such a streamlined, intelligent resource activity feed may be enabled by one or more micro-applications, or “microapps,” that can interface with underlying associated resources using APIs or the like. The responsive actions may be user-initiated activities that are taken within the microapps and that provide inputs to the underlying applications through the API or other interface. The actions a user performs within the microapp may, for example, be designed to address specific common problems and use cases quickly and easily, adding to increased user productivity (e.g., request personal time off, submit a help desk ticket, etc.). In some embodiments, notifications from such event-driven microapps may additionally or alternatively be pushed to clients 202 to notify a user 524 of something that requires the user's attention (e.g., approval of an expense report, new course available for registration, etc.).

FIG. 5C is a block diagram similar to that shown in FIG. 5B but in which the available resources (e.g., SaaS applications, web applications, Windows applications, Linux applications, desktops, file repositories and/or file sharing systems, and other data) are represented by a single box 526 labeled “systems of record,” and further in which several different services are included within the resource management services block 502. As explained below, the services shown in FIG. 5C may enable the provision of a streamlined resource activity feed and/or notification process for a client 202. In the example shown, in addition to the client interface service 514 discussed above, the illustrated services include a microapp service 528, a data integration provider service 530, a credential wallet service 532, an active data cache service 534, an analytics service 536, and a notification service 538. In various embodiments, the services shown in FIG. 5C may be employed either in addition to or instead of the different services shown in FIG. 5B. Further, as noted above in connection with FIG. 5B, it should be appreciated that, in other implementations, one or more (or all) of the components of the resource management services 502 shown in FIG. 5C may alternatively be located outside the cloud computing environment 512, such as within a data center hosted by an organization.

In some embodiments, a microapp may be a single use case made available to users to streamline functionality from complex enterprise applications. Microapps may, for example, utilize APIs available within SaaS, web, or home-grown applications allowing users to see content without needing a full launch of the application or the need to switch context. Absent such microapps, users would need to launch an application, navigate to the action they need to perform, and then perform the action. Microapps may streamline routine tasks for frequently performed actions and provide users the ability to perform actions within the resource access application 522 without having to launch the native application. The system shown in FIG. 5C may, for example, aggregate relevant notifications, tasks, and insights, and thereby give the user 524 a dynamic productivity tool. In some embodiments, the resource activity feed may be intelligently populated by utilizing machine learning and artificial intelligence (AI) algorithms. Further, in some implementations, microapps may be configured within the cloud computing environment 512, thus giving administrators a powerful tool to create more productive workflows, without the need for additional infrastructure. Whether pushed to a user or initiated by a user, microapps may provide short cuts that simplify and streamline key tasks that would otherwise require opening full enterprise applications. In some embodiments, out-of-the-box templates may allow administrators with API account permissions to build microapp solutions targeted for their needs. Administrators may also, in some embodiments, be provided with the tools they need to build custom microapps.

Referring to FIG. 5C, the systems of record 526 may represent the applications and/or other resources the resource management services 502 may interact with to create microapps. These resources may be SaaS applications, legacy applications, or homegrown applications, and can be hosted on-premises or within a cloud computing environment. Connectors with out-of-the-box templates for several applications may be provided and integration with other applications may additionally or alternatively be configured through a microapp page builder. Such a microapp page builder may, for example, connect to legacy, on-premises, and SaaS systems by creating streamlined user workflows via microapp actions. The resource management services 502, and in particular the data integration provider service 530, may, for example, support REST API, JSON, OData-JSON, and 6ML. As explained in more detail below, the data integration provider service 530 may also write back to the systems of record, for example, using OAuth2 or a service account.

In some embodiments, the microapp service 528 may be a single-tenant service responsible for creating the microapps. The microapp service 528 may send raw events, pulled from the systems of record 526, to the analytics service 536 for processing. The microapp service may, for example, periodically pull active data from the systems of record 526.

In some embodiments, the active data cache service 534 may be single-tenant and may store all configuration information and microapp data. It may, for example, utilize a per-tenant database encryption key and per-tenant database credentials.

In some embodiments, the credential wallet service 532 may store encrypted service credentials for the systems of record 526 and user OAuth2 tokens.

In some embodiments, the data integration provider service 530 may interact with the systems of record 526 to decrypt end-user credentials and write back actions to the systems of record 526 under the identity of the end-user. The write-back actions may, for example, utilize a user's actual account to ensure all actions performed are compliant with data policies of the application or other resource being interacted with.

In some embodiments, the analytics service 536 may process the raw events received from the microapp service 528 to create targeted scored notifications and send such notifications to the notification service 538.

Finally, in some embodiments, the notification service 538 may process any notifications it receives from the analytics service 536. In some implementations, the notification service 538 may store the notifications in a database to be later served in an activity feed. In other embodiments, the notification service 538 may additionally or alternatively send the notifications out immediately to the client 202 as a push notification to the user 524.

In some embodiments, a process for synchronizing with the systems of record 526 and generating notifications may operate as follows. The microapp service 528 may retrieve encrypted service account credentials for the systems of record 526 from the credential wallet service 532 and request a sync with the data integration provider service 530. The data integration provider service 530 may then decrypt the service account credentials and use those credentials to retrieve data from the systems of record 526. The data integration provider service 530 may then stream the retrieved data to the microapp service 528. The microapp service 528 may store the received systems of record data in the active data cache service 534 and also send raw events to the analytics service 536. The analytics service 536 may create targeted scored notifications and send such notifications to the notification service 538. The notification service 538 may store the notifications in a database to be later served in an activity feed and/or may send the notifications out immediately to the client 202 as a push notification to the user 524.

In some embodiments, a process for processing a user-initiated action via a microapp may operate as follows. The client 202 may receive data from the microapp service 528 (via the client interface service 514) to render information corresponding to the microapp. The microapp service 528 may receive data from the active data cache service 534 to support that rendering. The user 524 may invoke an action from the microapp, causing the resource access application 522 to send an action request to the microapp service 528 (via the client interface service 514). The microapp service 528 may then retrieve from the credential wallet service 532 an encrypted Oauth2 token for the system of record for which the action is to be invoked, and may send the action to the data integration provider service 530 together with the encrypted OAuth2 token. The data integration provider service 530 may then decrypt the OAuth2 token and write the action to the appropriate system of record under the identity of the user 524. The data integration provider service 530 may then read back changed data from the written-to system of record and send that changed data to the microapp service 528. The microapp service 528 may then update the active data cache service 534 with the updated data and cause a message to be sent to the resource access application 522 (via the client interface service 514) notifying the user 524 that the action was successfully completed.

In some embodiments, in addition to or in lieu of the functionality described above, the resource management services 502 may provide users the ability to search for relevant information across all files and applications. A simple keyword search may, for example, be used to find application resources, SaaS applications, desktops, files, etc. This functionality may enhance user productivity and efficiency as application and data sprawl is prevalent across all organizations.

In other embodiments, in addition to or in lieu of the functionality described above, the resource management services 502 may enable virtual assistance functionality that allows users to remain productive and take quick actions. Users may, for example, interact with the “Virtual Assistant” and ask questions such as “What is Bob Smith's phone number?” or “What absences are pending my approval?” The resource management services 502 may, for example, parse these requests and respond because they are integrated with multiple systems on the back-end. In some embodiments, users may be able to interact with the virtual assistant through either the resource access application 522 or directly from another resource, such as Microsoft Teams. This feature may allow employees to work efficiently, stay organized, and deliver only the specific information they're looking for.

F. Systems and Methods for Delivering Virtualized Applications and/or Desktops to Client Devices

FIG. 6A is a block diagram illustrating key components of a resource delivery system 600 that may enable a client device 202 to remotely access one or more virtual applications or desktops running on one or more shared computing resources 602. The shared computing resources 602 may include physical machines and/or virtual (e.g., hypervisor driven) machines, and may be located at a data center, within a cloud computing environment, or elsewhere. As described in more detail below, such shared computing resources 602 may implement one or more resource delivery agents 604, including one or more server delivery agents 604a and/or one or more desktop delivery agents 604b. The Virtual Delivery Agents (VDAs) of the Citrix Virtual Apps and Desktops™ system offered by Citrix Systems, Inc., of Fort Lauderdale, Fla., are example implementations of the resource delivery agents 604. In some implementations, the resource delivery system 600 may give an information technology (IT) department of an organization control of virtual machines, applications, licensing, and security while providing “anywhere access” for any device. As described below, the resource delivery system 600 may enable end users to run applications and/or desktops independently of the operating system and interface of the end user's device. Further, the resource delivery system 600 may enable administrators to manage the network and control access from selected devices or from all devices, as well as to manage an entire network from a single data center.

The resource delivery system 600 shown in FIG. 6A may, for example, correspond to an implementation of a Citrix Virtual Apps and Desktops™ system offered by Citrix Systems, Inc., of Fort Lauderdale, Fla. Such systems employ a unified architecture called FlexCast Management Architecture (FMA). Among other things, FMA provides the ability to run multiple versions of Citrix Virtual Apps or Citrix Virtual Desktops™ as well as integrated provisioning.

As shown in FIG. 6A, in addition to the shared computing resources 602, the resource delivery system 600 may include a gateway 608, a client access manager 610, one or more resource delivery controllers 612, a resource manager 614, a resource director 616, a license manager 618, one or more databases 620, and an Active Directory (AD) 622 or other directory service.

The resource delivery controller(s) 612 may be the central management component of the resource delivery system 600. In some implementations, the resource delivery controller(s) 612 may be installed on at least one server in a data center of an organization. The Delivery Controller of the Citrix Virtual Apps and Desktops™ system offered by Citrix Systems, Inc., of Fort Lauderdale, Fla., is one example implementation of the resource delivery controller(s) 612. For reliability and availability, respective resource delivery controllers 612 may be installed on multiple servers. The resource delivery controller(s) 612 may communicate with the shared computing resources 602 to distribute applications and/or desktops, authenticate and manage user access, broker connections between client devices 202 and resource delivery agents 604 running on respective shared computing resources 602, optimize use connections, and/or load-balance use connections. As described in more detail below, a broker service 632 (shown in FIGS. 6B-6D) of the resource delivery controller(s) 612 may interact with the database(s) 620 to track which users are logged on and where, what session resources the users have, and if users need to reconnect to existing applications. In some implementations, the broker service 632 may execute PowerShell commands and communicate with broker agents 656 (shown in FIG. 6D) of the resource delivery agents 604 over transmission control protocol (TCP) port “80.” A monitor service 660 (shown in FIG. 6D) may also be provided by the resource delivery controller(s) 612 to collect historical data concerning the operation of the resource delivery controller(s) 612 and write such data to the database(s) 620. In some implementations, such a monitor service 660 may use TCP port “80” or “443.”

The resource delivery controller(s) 612 may manage the state of desktops, starting and stopping them based on demand and administrative configuration. In some implementations, the resource delivery controller(s) 612 may also enable the adjustment of user profiles (stored within the database(s) 620) to manage user personalization settings in virtualized or physical Windows environments.

In some implementations, the database(s) 620 may include at least one Microsoft Structured Query Language (SQL) Server database in which configuration and session information may be stored. As noted above, the database(s) 620 may store the data collected and managed by the services that make up the resource delivery controller(s) 612. In some implementations, the database(s) 620 may be provided within a data center of an organization and may have a persistent connection to the resource delivery controller(s) 612. Although not illustrated in FIG. 6A, it should be appreciated that the resource delivery system 600 may also include respective databases associated with the resource manager 614, the resource director 616, and the license manager 618 to store data collected and/or used by those components.

The resource delivery agents 604 may be installed on physical or virtual machines that are made available to deliver applications or desktops to users. The resource delivery agents 604 may enable such machines to register with the resource delivery controller(s) 612. The registration of a machine with the resource delivery controller(s) 612 may cause that machine and the resources it is hosting to be made available to users. The resource delivery agents 604 may establish and manage the connections between the machines on which they are installed and client devices 202. The resource delivery agents 604 may also verify that a license is available for the user and/or session, and may apply policies that are configured for the session.

The resource delivery agents 604 may communicate session information to the broker service 632 (shown in FIGS. 6B-6D) of the resource delivery controller(s) 612 through the broker agents 656 (shown in FIG. 6D) in the resource delivery agents 604. Such broker agents 656 may host multiple plugins and collect real-time data. In some implementations, the broker agents 656 may communicate with the resource delivery controller(s) 612 over TCP port “80.” In some implementations, the resource delivery agents 604 may operate with Single-session and/or Multi-session Windows operating systems. The resource delivery agents 604 for Multi-session Windows operating systems may allow multiple users to connect to the server at one time. The resource delivery agents 604 for Single-session Windows operating systems, on the other hand, may allow only one user to connect to the desktop at a time. In some implementations, one or more the resource delivery agents 604 may alternatively operate with a Linux operating system.

When users connect from outside one or more corporate firewalls, e.g., firewalls 626a and 626b shown in FIG. 6A, the gateway 608 may be used to secure such connections with Transport Layer Security (TLS). The gateway 608 may, for example, be a Secure Socket Layer (SLL) Virtual Private Network (VPN) appliance that is deployed in a demilitarized zone (DMZ) 628. The gateway 608 may thus provide a single secure point of access through the corporate firewall 626.

The client access manager 610 of the resource delivery system 600 may authenticate users and manage stores of desktops and/or applications that are available for users to access. In some implementations, the client access manager 610 may provide an application “storefront” for an enterprise, which may provide users with self-service access to the desktops and/or applications that the enterprise opts to make available to them. In some implementations, the client access manager 610 may also keep track of users' application subscriptions, shortcut names, and other data. Tracking such data may, for example, help ensure that users have a consistent experience across multiple devices.

As shown in FIG. 6A, a resource access application 624 may be installed on client devices 202 or other endpoints (such as virtual desktops). Such resource access applications 624 may provide users with quick, secure, self-service access to documents, applications, and/or desktops. The resource access application 624 may, for example, provide on-demand access to Windows, web, and/or Software as a Service (SaaS) applications. The Citrix Workspace™ app, offered by Citrix Systems, Inc., of Fort Lauderdale, Fla., is one example implementation of such a client-based version of the resource access application 624. In some implementations, the resource access application 624 may alternatively operate on a web server (not shown in FIG. 6A) and may be accessed using a web browser (also not shown in FIG. 6A) installed on the client device 202. In some embodiments, for example, the resource access application 624 may be provided as a hypertext markup language 5 (HTML5) service and may be accessed using an HTML5-compatible web browser. The Citrix Workspace™ app for HTML5, offered by Citrix Systems, Inc., of Fort Lauderdale, Fla., is one example implementation of such a web-based version of the resource access application 624.

In some embodiments, the resource access application 624 may intercept network communications from a network stack used by the one or more applications. For example, the resource access application 624 may intercept a network communication at any point in a network stack and redirect the network communication to a destination desired, managed, and/or controlled by the resource access application 624, for example, to intercept and redirect a transport layer connection to an IP address and port controlled and/or managed by resource access application 624. The resource access application 624 may thus, in some embodiments, transparently intercept any protocol layer below the transport layer, such as the network layer, and any protocol layer above the transport layer, such as the session, presentation, or application layers. The resource access application 624 may, for example, interface with the transport layer to secure, optimize, accelerate, route, and/or load-balance any communications provided via any protocol carried by the transport layer.

In some embodiments, the resource access application 624 may be implemented as an Independent Computing Architecture (ICA) client developed by Citrix Systems, Inc. The resource access application 624 may perform acceleration, streaming, monitoring, and/or other operations. For example, the resource access application 624 may accelerate streaming an application from a shared computing resource 602 running a resource delivery agent 604 to the client device 202. The resource access application 624 may also perform endpoint detection/scanning and/or collect endpoint information about the client 202. For example, the resource access application 624 may identify and determine one or more client-side attributes, such as: the operating system and/or a version of an operating system, a service pack of the operating system, a running service, a running process, a file, presence or versions of various applications of the client, such as antivirus, firewall, security, and/or other software.

The resource manager 614 shown in FIG. 6A, may provide a console from which the configuration and management of applications and desktops that are to be made available to users may be controlled. The Studio component of the Citrix Virtual Apps and Desktops™ system offered by Citrix Systems, Inc., of Fort Lauderdale, Fla., is one example implementation of the resource manager 614. In some implementations, the resource manager 614 may eliminate the need for separate management consoles for managing delivery of applications and desktops. In some embodiments, the resource manager 614 may provide one or more wizards to guide system administrators through environment setup, creating workloads to host applications and desktops, and assigning applications and desktops to users. In some implementations, the resource manager 614 may also be used to allocate and track licenses for the resource delivery system 600. In some embodiments, the resource manager 614 may get the information it displays from the broker service 632 of the resource delivery controller(s) 612, e.g., communicating over TCP port “80.”

The resource director 616 may, for example, be a web-based tool that enables IT support and help desk teams to monitor an environment, troubleshoot issues before they become system-critical, and perform support tasks for end users. The Director component of the Citrix Virtual Apps and Desktops™ system offered by Citrix Systems, Inc., of Fort Lauderdale, Fla., is one example implementation of the resource director 616. In some implementations, a single deployment of the resource director 616 may be used to connect to and monitor multiple resource delivery systems 600, such as that shown in FIG. 6A. Examples of information that may be displayed by the resource director 616 include (A) real-time session data from the broker service 632 of the resource delivery controller(s) 612, which may include data the broker service 632 gets from the broker agent 656 in the resource delivery agents 604, and (B) historical data about the resource delivery system 622 that may be received, for example, from the monitor service 660 in the resource delivery controller(s) 612. In some implementations, the resource director 616 may use performance and heuristics data captured by the gateway 608 (described below) to build analytics from the data and then presents such analytics to system administrators. Further, in some implementations, the resource director 616 may allow system administrators to view and interact with a user's sessions, e.g., using Windows Remote Assistance.

The license manager 618, as its name implies, may enable the management of licenses within the resource delivery system 600. In some implementations, the license manager 618 may communicate with the resource delivery controller(s) 612 to manage licensing for a user's session and with the resource manager 614 to allocate license files.

As noted above, in some implementations, the shared computing resources 602 shown in FIG. 6A may include one or more virtual machines. These can be virtual machines that are used to host applications and/or desktops, as well as virtual machines that are used to host the other components of the resource delivery system 600. In some implementations, a hypervisor may be installed on a host computer to run the hypervisor and hosting virtual machines.

Although not depicted in FIG. 6A, in some implementations, the resource delivery system 600 may additionally include a performance monitoring service or agent. In some embodiments, one or more dedicated servers (or a dedicated service in a cloud-based environment) may be employed to perform performance monitoring. Performance monitoring may be performed using data collection, aggregation, analysis, management and reporting, for example by software, hardware or a combination thereof. Performance monitoring may include one or more agents for performing monitoring, measurement and data collection activities on one or more clients 202 (e.g., as a part of the resource access application 624), one or more servers 204, or one or more other system component(s). In general, the monitoring agents may execute transparently (e.g., in the background) to any application and/or user of the device. In some embodiments, such a monitoring agent may be implemented as components of Citrix Analytics™ by Citrix Systems, Inc., of Fort Lauderdale, Fla.

The monitoring agents may, for example, monitor, measure, collect, and/or analyze data on a frequency (e.g., a predetermined frequency), based upon an occurrence of given event(s), or in real time during operation of the resource delivery system 600. The monitoring agents may, for example, monitor resource consumption and/or performance of hardware, software, and/or communications resources of the clients 202, the gateway 608 (and/or any other components in the DMZ 628), and/or the resource delivery controller(s) 612, the shared computing resources 602, the resource delivery agents 604, or any other components shown in FIG. 6A. For example, network connections such as a transport layer connection, network latency, bandwidth utilization, end-user response times, application usage and performance, session connections to an application, cache usage, memory usage, processor usage, storage usage, database transactions, client and/or server utilization, active users, duration of user activity, application crashes, errors, or hangs, the time required to log-in to an application, a server, or the application delivery system, and/or other performance conditions and metrics may be monitored.

The monitoring agents may provide application performance management for the resource delivery system 600. For example, based upon one or more monitored performance conditions or metrics, the resource delivery system 600 may be dynamically adjusted, for example periodically or in real-time, to optimize application delivery by the resource delivery agents 604 to the clients 202 based upon network environment performance and conditions

FIG. 6B illustrates an example deployment 630 of a resource delivery system 600, such as that shown in FIG. 6A. Such a deployment may be referred to as a “Site.” A Site may be made up of machines with dedicated roles that allow for scalability, high availability, and failover, and may provide a solution that is secure by design. As discussed above, such a Site may include servers and/or desktop machines installed with resource delivery agents 604, and one or more resource delivery controller(s) 612, which may manage access to such servers/machines. FIG. 6B illustrates one such resource delivery agent 604, and one such resource delivery controller 612. As shown in FIG. 6B, the resource delivery controller 612 may include a broker service 632. The resource delivery agent 604 may enable users to connect to desktops and/or applications. It may be installed on server or desktop machines in a datacenter for most delivery methods, but it may also be installed on physical personal computers (PCs) for Remote PC Access. In some implementations, the resource delivery controller 612 may be made up of independent Windows services that may manage resources, applications, and/or desktops, and may optimize and balance user connections.

In some embodiments, client devices 202 may not directly access the resource delivery controller 612. Instead, the resource delivery agent 604 and the client access manager 610 may serve as intermediaries between client devices 202 and the resource delivery controller 612. When users log on using the client access manager 610, their credentials may pass through to the broker service 632 on the resource delivery controller 612. The broker service 632 may then obtain profiles and available resources based on the policies set for them.

FIG. 6C illustrates an example process for handling user connections within the deployment 630 shown in FIG. 6B. As indicated by arrows 634 and 635, to start a session, a user may cause the client device 202 to connect (via the gateway 608) to the client access manager 610. Such a connection may, for example, be established using the resource access application 624. As noted above, the resource access application 624 may either be installed on the client device 202 or accessible from a web server via a web browser on the client device 202.

As indicated by arrow 636, the user's credentials may then move through this pathway to access the broker service 632 of resource delivery controller 612. In some implementations, such communications may be encrypted to protect the security of such credentials. The broker service 632 may determine which desktops and/or applications the user is allowed to access. After the credentials have been verified, information about available applications and/or desktops may be sent back to the client device 202 through the pathway between the client access manager 610 and the resource access application 624, as indicated by arrows 638, 640, and 641. The user of the client device 202 may thus be provided with a list of available applications and/or desktops. When the user selects an application or desktop from this list, an indication of the selected resource goes back down the previously described pathway to the resource delivery controller 612. The resource delivery controller 612 may then select an appropriate resource delivery agent 604 to host the selected applications or desktop.

As indicated by arrow 642, the resource delivery controller 612 may send a message to the selected resource delivery agent 604 with the user's credentials, and may then send pertinent data about the user and the connection to the resource delivery agent 604. The resource delivery agent 604 may then accept the connection and, as indicated by arrows 644, 638, 640, and 641, may send a set of access parameters (stored in an access parameter stack 646a) back through the same pathways to the resource access application 624. In particular, the set of access parameters may be collected by the client access manager 610 and then sent to the resource access application 624 where they may be stored as an access parameter file 646b. In some implementations, the access parameter file 646b may be created as part of a protocol conversation between the client access manager 610 and the resource access application 624. In other implementations, the client access manager 610 may convert the access parameters to the file 646b, and that file 646b may then be downloaded to the client device 202. In some implementations, the access parameters may remain encrypted throughout this process.

The access parameter file 646b that is then stored on the client device 202 may be used to establish a direct connection 648 between the client device 202 and the access parameter stack 646a running on the resource delivery agent 604. As illustrated, the connection 648 between the client device 202 and the resource delivery agent 604 may use a gateway protocol 650. In some implementations, the gateway protocol 650 may include a feature that enables the client device 202 to immediately reconnect to the resource delivery agent 604 if the connection 648 is lost, rather than having to relaunch through the management infrastructure (including the client access manager 610, the resource delivery controller 612, etc.).

After the client device 202 connects to the resource delivery agent 604, the resource delivery agent 604 may notify the resource delivery controller 612 that the user is logged on. The resource delivery controller 612 may then send this information to the database(s) 620 (shown in FIGS. 6A, 6B and 6D) and the monitor service 660 (shown in FIG. 6D) of the delivery controller 612 may also start logging data in the database(s) 620.

Such sessions between client devices 202 and resource delivery agents 604 produce data that system administrators can access through the resource manager 614 and/or the resource director 616. FIG. 6D shows examples of paths through which the resource manager 614 and the resource director 616 may access such data in some embodiments. As indicated by the arrows 652 and 654, administrators may use the resource manager 614 to access real-time data from the broker agent 656 of a resource delivery agent 604 (via the broker service 632 of the resource delivery controller 612). The resource director 616 may access the same data, as indicated by arrows 658 and 654, plus any historical data the monitor service 660 of the resource delivery controller 612 stores in the database(s) 620, as indicated by arrows 658, 662 and 664. Further, as indicated by arrow 666, the resource director 616 may also access data from the gateway 608 for help desk support and troubleshooting.

Within the resource delivery controller 612, the broker service 632 may report session data for every session on the machine providing real-time data. The monitor service 660 may also track the real-time data and store it as historical data in the database(s) 620. In some implementations, the resource manager 614 may communicate with the broker service 632 and may access real-time data. The resource director 616 may communicate with the broker service 632 to access the database(s) 620.

An example process for enabling the delivery of applications and/or desktops will now be described. First, the machines that are to deliver applications and/or desktops may be set up with “Machine Catalogs.” Then, “Delivery Groups” may be created that specify the applications and/or desktops that are to be made available (using machines in the Machine Catalogs), and which users can access them. In some implementations, “Application Groups” may also be created to manage collections of applications.

Machine Catalogs are collections of virtual or physical machines that can be managed as a single entity. These machines, and the application and/or virtual desktops on them, are the resources that may be made available to users. All the machines in a Machine Catalog may have the same operating system and the same resource delivery agent 604 installed. They may also have the same applications and/or virtual desktops.

In some implementations, a master image may be created and used to create identical virtual machines in the catalog. For virtual machines, the provisioning method may be specified for the machines in that catalog. Valid machine types may, for example, include “Multi-session OS,” “Single-session OS,” and “Remote PC access.” A Multi-session OS machine is a virtual or physical machine with a multi-session operating system. Such a machine may be used to deliver published applications (also known as server-based hosted applications) and published desktops (also known as server-hosted desktops). These machines may allow multiple users to connect to them at one time. A Single-session OS machine is a virtual or physical machine with a single-session operating system. Such a machine may be used to deliver Virtual Desktop Infrastructure (VDI) desktops (desktops running single-session OSs that can optionally be personalized), virtual machine (VM)-hosted apps (applications from single-session OSs), and hosted physical desktops. Only one user at a time can connect to each of these desktops. A Remote PC access machine may enable remote users to access their physical office PCs from any device running the resource access application 624.

Delivery Groups may specify which users can access which applications and/or desktops on which machines. Delivery Groups may include machines from the Machine Catalogs, and Active Directory users who have access to the Site. In some implementations, users may be assigned to Delivery Groups by their Active Directory group, because Active Directory groups and Delivery Groups are ways to group users with similar requirements.

Delivery Groups may contain machines from more than one Machine Catalog, and Machine Catalogs may contribute machines to more than one Delivery Group. In at least some implementations, however, individual machines can only belong to one Delivery Group at a time.

The specific resources that users in the Delivery Group can access may be defined. For example, to deliver different applications to different users, all of the applications may be installed on the master image for one Machine Catalog and enough machines may be created in that catalog to distribute among several Delivery Groups. Delivery Groups may then be configured to deliver a different subset of applications that are installed on the machines.

Application Groups may provide application management and resource control advantages over using more Delivery Groups. Using a “tag restriction” feature, existing machines may be used for more than one “publishing” task, saving the costs of deployment and managing additional machines. A tag restriction can be thought of as subdividing (or partitioning) the machines in a Delivery Group. Application Groups may also be helpful when isolating and troubleshooting a subset of machines in a Delivery Group.

“Tags” may be strings that identify items such as machines, applications, desktops, Delivery Groups, Application Groups, and policies. After creating a tag and adding it to an item, certain operations may be tailored to apply to only items that have a specified tag.

In some implementations, tags may be used to tailor search displays is the resource manager 614. For example, to display only applications that have been optimized for testers, a tag named “test” may be created and may then be added (applied) to those applications. A search performed by the resource manager 614 may then be filtered with the tag “test”.

In some implementations, tags may be used to “publish” applications from an Application Group or specific desktops from a Delivery Group, considering only a subset of the machines in selected Delivery Groups. Using an Application Group or desktops with a tag restriction may be helpful when isolating and troubleshooting a subset of machines in a Delivery Group.

In some implementations, tags may be used to schedule periodic restarts for a subset of machines in a Delivery Group. Using a tag restriction for machines may, for example, enable the use of new PowerShell cmdlets to configure multiple restart schedules for subsets of machines in a Delivery Group.

In some implementations, tags may be used to tailor the application (assignment) of particular policies to a subset of machines in Delivery Groups, Delivery Group types, or organizational units (OUs) of a Site that have (or do not have) a specified tag. For example, if a particular policy is to be applied only to the more powerful workstations, a tag named “high power” may be applied to those machines and the policy may be set to apply to only machines to which the high power tag has been applied. Tags may additionally or alternatively be applied to particular Delivery Groups and one or more policies may be set to apply only the Delivery Groups to which such tags have been applied.

In some embodiments, the resource manager 614 may be used to create or edit a tag restriction for a desktop in a shared Delivery Group or an Application Group. In some implementations, creating such a tag restriction may involve several steps. First, a tag may be created and then added (applied) to one or more machines. Second a group may be created or edited to include the tag restriction, thus restricting launches to machines with the applied tag. A tag restriction may extend the machine selection process of the broker service 632. In particular, the broker service 632 may select a machine from an associated Delivery Group subject to access policy, configured user lists, zone preference, and launch readiness, plus the tag restriction (if present). For applications, the broker service 632 may fall back to other Delivery Groups in priority order, applying the same machine selection rules for each considered Delivery Group.

As noted above, the resource delivery system 600 described in connection with FIGS. 6A-6D may provide virtualization solutions that give administrators control of virtual machines, applications, and security while providing anywhere access for any device. As was also noted above, the resource delivery system 600 may also enable end users to access applications and desktops independently of the operating systems and interfaces of the client devices 202 such end users are operating.

In some implementations, one or more components of the resource delivery system 600 may be provided as a service within a cloud-based computing environment. FIG. 6E illustrates an example of such an implementation. As shown in FIG. 6E, one or more cloud connectors 668 may enable various resources at one or more locations 670 outside of a cloud computing environment 672 to interface with various components within the cloud computing environment 672. As illustrated, resource location(s) 670 may include the machines and other resources that deliver applications and/or desktops to client devices 202. As indicated by dashed lines, the resource location 670 may optionally include the gateway 608 and/or the client access manager 610 previously described. In the illustrated example, the resource delivery controller(s) 612, the resource manager 614, the resource director 616, the license manager 618, and the database(s) 620 are all provided within the cloud computing environment 672. Further, as shown in FIG. 6E, a configuration manager 674 may additionally be hosted within the cloud computing environment 672 in some implementations. Examples of management functions that may be performed by the configuration manager 674 are described below. In some implementations, the cloud computing environment 672 may correspond to a public cloud computing infrastructure, such as AZURE CLOUD provided by Microsoft Corporation of Redmond, Wash., or AMAZON WEB SERVICES provided by Amazon.com, Inc., of Seattle, Wash.

In addition to serving as a channel for communication between the cloud computing environment 672 and the resource location(s) 670, the cloud connectors 668 may enable cloud management without requiring any complex networking or infrastructure configuration such as virtual private networks (VPNs) or Internet Protocol Security (IPsec) tunnels.

As noted above, the resource delivery controller(s) 612 may serve as the central control layer component in a deployment. The resource delivery controller(s) 612 may communicate through the cloud connectors 668 in each resource location 670 to distribute applications and/or desktops, authenticate and manage user access, broker connections between users and their virtual desktops and/or applications, optimize use connections, and/or load-balance use connections. In some implementations, the resource delivery controller(s) 612 may additionally track which users are logged on and where, which session resources the users have, and if users need to reconnect to existing applications. The resource delivery controller(s) 612 may further manage the state of desktops, starting and stopping them based on demand and administrative configuration, in some implementations.

The configuration manager 674 in the cloud computing environment 672 may (A) enable administrators to specify which services are to be made available to users via the resource access application, (B) customize the uniform resource locator (URL) that the resource access application 624 is to use to access the available resources, (C) customize the appearance of the user interface provided by the resource access application, such as logos, color, and preferences, (D) specify how users are to authenticate to the system, such as using the Active Directory 622, and/or (E) specify external connectivity for the resource locations 670.

As noted above, a resource location 670 may include at least one cloud connector 668 that serves as the communications channel between the components in the cloud computing environment 672 and the components in the resource location 670. In the resource location 670, the cloud connector(s) may act as a proxy for the resource delivery controller(s) 612 in the cloud computing environment 672.

As noted above, the physical or virtual machines that deliver applications and/or desktops may include resource delivery agents 604a, 604b. The resource delivery agents 604 may register with at least one cloud connector 668. After registration, connections may be brokered from those resources to users. The resource delivery agents 604 may further establish and manage the connection between the machine and the client device 202, and apply policies that are configured for the session. The resource delivery agents 604 may communicate session information to the cloud connector 668 through the broker agent 656 (shown in FIG. 6D) in the resource delivery agent 604. As noted above, in some implementations, such a broker agent 656 may host multiple plugins and collect real-time data.

A host connection may be established that enables communication between components in the cloud computing environment 672 and the resource delivery agents 604 on the shared computing resources 602. Specifications for such host connections may include (A) the address and credentials to access the host, (B) the tool that is to be used to create VMs, (C) the storage method to use, (D) the machines to use for storage, and/or (E) which network the VMs will use.

G. Example Architecture of a Resource Virtualization Server

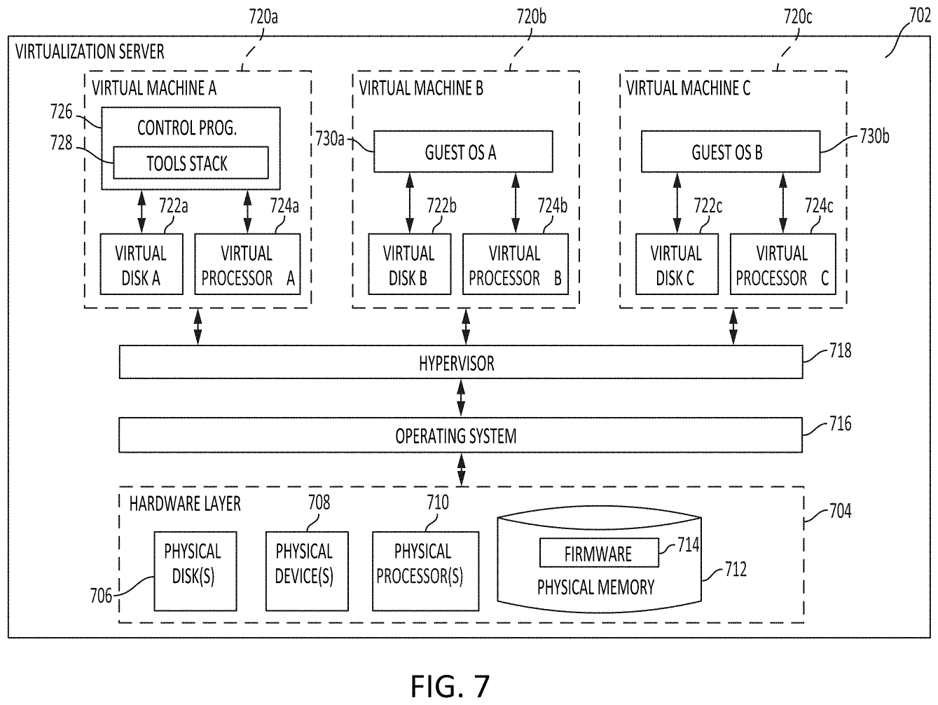

FIG. 7 shows an example architecture of an illustrative resource virtualization server 702. As shown, the resource virtualization server 702 may be configured to provide virtual desktops and/or virtual applications to one or more client access devices, such as the clients 202. As used herein, a desktop may refer to a graphical environment (e.g., a graphical user interface) or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Instances of the operating system may be physical (e.g., one operating system per physical device) or virtual (e.g., many instances of an OS running on a single physical device). The applications may be executed on a local device, or executed on a remotely located device (e.g., remoted).

The virtualization server 702 illustrated in FIG. 7 may be deployed as and/or implemented by one or more of the servers 204 described above, the servers that make up a virtualization server system, or by other known computing devices. Included in the virtualization server 702 is a hardware layer 704 that may include one or more physical disks 706, one or more physical devices 708, one or more physical processors 710, and one or more physical memories 712. In some embodiments, firmware 714 may be stored within a memory element in physical memory 712 and be executed by one or more of the physical processors 710. The virtualization server 702 may further include an operating system 716 that may be stored in a memory element in physical memory 712 and executed by one or more of physical processors 710. Still further, a hypervisor 718 may be stored in a memory element in the physical memory 712 and be executed by one or more of the physical processors 710. Presence of the operating system 716 may be optional such as in a case where the hypervisor 718 is a Type 1 hypervisor; that is, a bare-metal hypervisor installed directly on the hardware layer 704. In some implementations, the hypervisor 718 may be a Type 2 hypervisor, which executes on a host operating system, such as the OS 716, which may provide virtualization services such as I/O device support and memory management.

Executing on one or more of the physical processors 710 may be one or more virtual machines 720a-c (generally 720). The virtual machines 720 may have respective virtual disks 722a-c and virtual processors 724a-c. In some embodiments, a first virtual machine 720a may execute, using the virtual processor 724a, a control program 726 that includes a tools stack 728. The control program 726 may be referred to as a control virtual machine, Domain 0, Dom0, or other virtual machine used for system administration and/or control. In some embodiments, one or more of the virtual machines 720b-c may execute, using a virtual processor 724b-c, a guest operating system 730a-b (generally 730).

The physical devices 708 may include, for example, a network interface card, a video card, an input device (e.g., a keyboard, a mouse, a scanner, etc.), an output device (e.g., a monitor, a display device, speakers, a printer, etc.), a storage device (e.g., an optical drive), a Universal Serial Bus (USB) connection, a network element (e.g., router, firewall, network address translator, load balancer, virtual private network (VPN) gateway, Dynamic Host Configuration Protocol (DHCP) router, etc.), or any device connected to or communicating with virtualization server 702. The physical memory 712 in hardware layer 704 may include any type of memory. The physical memory 712 may store data, and in some embodiments may store one or more programs, or set of executable instructions. FIG. 7 illustrates an embodiment where firmware 714 is stored within physical memory 712 of virtualization server 702. Programs or executable instructions stored in physical memory 712 may be executed by the one or more of the processors 710 of the virtualization server 702.

The virtualization server 702 may also include hypervisor 718. In some embodiments, the hypervisor 718 may be a program executed by processors 710 on the virtualization server 702 to create and manage any number of virtual machines 720. The hypervisor 718 may be referred to as a virtual machine monitor, or platform virtualization software. In some embodiments, the hypervisor 718 may be any combination of executable instructions and hardware that monitors virtual machines 720 executing on a computing machine. The hypervisor 718 may be a Type 2 hypervisor, where the hypervisor executes within operating system 716 executing on virtualization server 702. The virtual machines may then execute at a layer above hypervisor 718. In some embodiments, the Type 2 hypervisor may execute within the context of a user's operating system such that the Type 2 hypervisor interacts with the user's operating system. In other embodiments, one or more virtualization servers 702 in a virtualization environment may instead include a Type 1 hypervisor (not shown). A Type 1 hypervisor may execute on the virtualization server 702 by directly accessing the hardware and resources within hardware layer 704. That is, while the Type 2 hypervisor 718 accesses system resources through host operating system 716, as shown, a Type 1 hypervisor may directly access all system resources without host operating system 716. A Type 1 hypervisor may execute directly on one or more physical processors 710 of the virtualization server 702, and may include program data stored in the physical memory 712.

The hypervisor 718, in some embodiments, may provide virtual resources to the guest operating systems 730 or control programs 726 executing on virtual machines 720 in any manner that simulates the operating systems 730 or control programs 726 having direct access to system resources. System resources may include, but are not limited to, the physical devices 708, the physical disks 706, the physical processors 710, physical memory 712, and any other component included in the hardware layer 704 of the virtualization server 702. The hypervisor 718 may be used to emulate virtual hardware, partition physical hardware, virtualize physical hardware, and/or execute virtual machines that provide access to computing environments. In still other embodiments, the hypervisor 718 may control processor scheduling and memory partitioning for the virtual machine 720 executing on the virtualization server 702. Examples of hypervisor 718 may include those manufactured by VMWare, Inc., of Palo Alto, Calif.; Xen Project® hypervisor, an open source product whose development is overseen by the open source XenProject.org community; Hyper-V®, Virtual Server®, and Virtual PC® hypervisors provided by Microsoft Corporation of Redmond, Wash.; or others. In some embodiments, the virtualization server 702 may execute a hypervisor 718 that creates a virtual machine platform on which the guest operating systems 730 may execute. In these embodiments, the virtualization server 702 may be referred to as a host server. An example of such a virtualization server is Citrix Hypervisor® provided by Citrix Systems, Inc., of Fort Lauderdale, Fla.

The hypervisor 718 may create one or more virtual machines 720b-c (generally 720) in which guest operating systems 730 execute. In some embodiments, the hypervisor 718 may load a virtual machine image to create a virtual machine 720. The virtual machine image may refer to a collection of data, states, instructions, etc. that make up an instance of a virtual machine. In other embodiments, the hypervisor 718 may execute guest operating system 730 within the virtual machine 720. In still other embodiments, the virtual machine 720 may execute the guest operating system 730.

In addition to creating the virtual machines 720, the hypervisor 718 may control the execution of at least one virtual machine 720. In other embodiments, the hypervisor 718 may present at least one virtual machine 720 with an abstraction of at least one hardware resource provided by the virtualization server 702 (e.g., any hardware resource available within hardware layer 704). In other embodiments, the hypervisor 718 may control the manner in which the virtual machines 720 access physical processors 710 available in the virtualization server 702. Controlling access to the physical processors 710 may include determining whether the virtual machine 720 should have access to the processor 710, and how physical processor capabilities are presented to the virtual machine 720.

As shown in FIG. 7, the virtualization server 702 may host or execute one or more virtual machines 720. A virtual machine 720 may be a set of executable instructions and/or user data that, when executed by processor 710, may imitate the operation of a physical computer such that the virtual machine 720 may execute programs and processes much like a physical computing device. While FIG. 7 illustrates an embodiment where the virtualization server 702 hosts three virtual machines 720, in other embodiments the virtualization server 702 may host any number of virtual machines 720. The hypervisor 718, in some embodiments, may provide the virtual machines 720 with unique virtual views of the physical hardware, including the memory 712, the processor 710, and other system resources 706, 708 available to the respective virtual machines 720. In some embodiments, the unique virtual view may be based on one or more of virtual machine permissions, application of a policy engine to one or more virtual machine identifiers, a user accessing a virtual machine, the applications executing on a virtual machine, networks accessed by a virtual machine, or any other desired criteria. For instance, the hypervisor 718 may create one or more unsecure virtual machines 720 and one or more secure virtual machines 720. The unsecure virtual machines 720 may be prevented from accessing resources, hardware, memory locations, and programs that the secure virtual machines 720 may be permitted to access. In other embodiments, the hypervisor 718 may provide the virtual machines 720 with substantially similar virtual views of the physical hardware, memory, processor, and other system resources available to the virtual machines 720.

The virtual machines 720 may include respective virtual disks 722a-c (generally 722) and virtual processors 724a-c (generally 724.) The virtual disk 722, in some embodiments, may be a virtualized view of one or more physical disks 706 of the virtualization server 702, or a portion of one or more physical disks 706 of the virtualization server 702. The virtualized view of the physical disks 706 may be generated, provided, and managed by the hypervisor 718. In some embodiments, the hypervisor 718 may provide the virtual machines 720 with unique views of the physical disks 706. Thus, in these embodiments, a particular virtual disk 722 included in a respective virtual machine 720 may be unique when compared with other virtual disks 722.

The virtual processor 724 may be a virtualized view of one or more physical processors 710 of the virtualization server 702. In some embodiments, the virtualized view of physical processors 710 may be generated, provided, and managed by the hypervisor 718. In some embodiments, the virtual processor 724 may have substantially all of the same characteristics of at least one physical processor 710. In other embodiments, the virtual processor 710 may provide a modified view of the physical processors 710 such that at least some of the characteristics of the virtual processor 724 are different from the characteristics of the corresponding physical processor 710.

H. Detailed Description of Example Embodiments of the System Providing Relevant Information During Online Meetings Introduced in Section a

As described above in Section A, the present disclosure relates to providing relevant information to a user during online meetings. As Section A explains, the computing system(s) 100 may receive inputs provided by the user 102 during an online meeting, may determine a topic of interest, may query the data source(s) 110 for information corresponding to the topic of interest, and may cause the client device 202 to display a representation of the information during the online meeting. FIG. 8 is a block diagram illustrating example components that may be used to implement the functionalities described herein.

As shown in FIG. 8, in some implementations, the computing system(s) 100 may include a meeting system 800a and an information system 800b. The meeting system 800a may include one or more processors 802a as well as one or more computer-readable mediums 804a that are encoded with instructions to be executed by the processor(s) 802a. The information system 800b may similarly include one or more processors 802b as well as one or more computer-readable mediums 804b that are encoded with instructions to be executed by the processor(s) 802b. In some implementations, such instructions may cause the processor(s) 802 to implement one or more, or possibly all, of the operations of the computing system(s) 100 described herein.

The processor(s) 802 and computer-readable medium(s) 804 may be disposed at any of a number of locations within a computing network such as the network environment 200 described above (in Section B) in connection with FIG. 2. In some implementations, for example, the processor(s) 802 and the computer-readable medium(s) 804 embodying one or more of the components described herein may be located within one or more of the servers 204 and/or the computing system 300 that are described above (in Sections B and C) in connection with FIGS. 2 and 3, and/or may be located within a cloud computing environment 400 such as that described above (in Section D) in connection with FIG. 4.

As shown in FIG. 8, in some implementations, the meeting system 800a may include a speech-to-text engine 810 and a user credentials engine 815. As also shown in FIG. 8, in some implementations, the information system 800b may include a natural language processing (NLP) engine 820, an information search engine 825, and an analytics engine 830. In other implementations, one or more of the engines shown in FIG. 8 may be implemented in a different configuration, for example, the user credentials engine 815 may be included in the information system 800b and/or the NLP engine 820 may be included in the meeting system 800a.

Components shown in FIG. 8 may be in wired or wireless communication with each other. For example, the meeting system 800a and the information system 800b may be in communication with each other, and the information system 800b may be in communication with the data sources 110 (e.g., via an API component 835).

As shown in FIG. 8, the data sources 110 may include one or more different types of data sources, such as a file sharing system 840, an email system 842, an intranet system 844, a web search engine 846, and/or other data source(s) 848. The data sources 110 may include more than one instance of the foregoing different types of data sources. For example, the data sources 110 may include a first email system, a second email system, a first intranet system and a second intranet system, etc. Examples of other data source(s) 848 may include a collaboration tool/system, an online/web-based collaboration tool, a knowledge base, a corporate/internal wiki, etc., accessible by the user 102 as being part of an organization (e.g., as an employee of a company).

The meeting system 800a may receive one or more inputs from the user 102, such as speech, which may be captured in the form of the audio 130 shown in FIGS. 1B and 1C. The speech-to-text engine 810 may be configured to convert audio data, corresponding to speech from the user 102, to text data representing the words spoken by the user 102. The speech-to-text engine 810 may use one or more techniques (e.g., automatic speech recognition techniques, transcription techniques, etc.) for processing the audio data and determining the text data. In some implementations, the speech-to-text engine 810 may employ one or more machine learning models (e.g., an acoustic model, a language model, a recurrent neural network (RNN), a RNN-transformer model, an encoder-decoder architecture, etc.).

In some implementations, the information system 800b may include the speech-to-text engine 810, and the meeting system 800a may send the audio data, corresponding to speech from the user 102, to the information system 800b for processing.

In some implementations, the user 102 may perform certain onboarding steps to enable the computing system(s) 100 to search for relevant information during online meetings at the data sources 110 to which the user 102 has access. During such onboarding steps, the user 102 may, for example, enable the meeting system 800a, via a meeting application (e.g., by providing permission/authorization inputs) installed at the client device 202 and hosted at the meeting system 800a, to automatically search for relevant information during online meetings that the user 102 is participating in. During the onboarding steps, the user 102 may additionally or alternatively indicate, via the meeting application, which data sources can be searched for the relevant information. In some implementations, the meeting application may display a list of available data sources that the meeting system 800a is able to search. This list, for example, may be based on one or more applications/systems being part of the same suite/family of products as the meeting application. For example, in the case where the meeting application is Microsoft Teams, the meeting application may be able to search other applications/systems provided by Microsoft®, such as, Outlook™ (example of the email system 842), OneDrive™ (example of a file sharing system 840), etc. In another example, the list of available data sources may be based on one or more applications/systems being hosted within a defined communication network. For example, the user 102 may be an employee of a company and may connect the client device 202 to a private company-hosted network, which enables the user 102 to access other resources (including applications and systems) at the client device 202 via the private network. The list of available data sources may be based on the resources accessible via the private network. In yet another example, the list of available data sources may be based on one or more applications/systems installed at the client device 202. The user 102 may select one or more data sources from the list of available data sources. In other implementations, the user 102 may add, via the meeting application, for one or more data sources that the user 102 wants to be searched during online meetings.

After indicating which data sources 110 the user 102 wants to be searched during online meetings, the user 102 may provide, via the meeting application, user credentials or an authorization token to enable the computing system(s) 100 to access the data sources 110. The user credentials or authorization tokens may be part of an Open Authorization (oAuth) standard. The user credentials engine 815, included at the meeting system 800a, may be configured to keep track of and store the user credentials or authorization tokens for the data sources 110.

In some implementations, the user credentials engine 815 may be included in the information system 800b, and the meeting system 800a may send the user credentials or authorization token, provided by the user 102, to the information system 800b.

The NLP engine 820 may be configured to process text data, corresponding to words spoken by the user 102, to determine one or more topics of interest for the user 102. The NLP engine 820 may receive the text data from the speech-to-text engine 810 to determine the topic(s) of interest. The NLP engine 820 may implement one or more NLP techniques (e.g., natural language understanding (NLU), parts of speech (POS) tagging, topic extraction, topic classification, topic labeling, etc.) to extract meaning from the words spoken by the user 102. In some implementations, the NLP engine 820 may employ one or more machine learning models (e.g., neural networks, classifiers, Latent Dirichlet Allocation (LDA), Latent Semantic Analysis, Support Vector Machines, deep learning models, encoder-decoder architecture, hybrid models, etc.). The NLP engine 820 may output text data corresponding to the determined topic(s) of interest. In some implementations, the NLP engine 820 may be included in the meeting system 800a, and the NLP engine 820 may send the determined topic(s) of interest to the information system 800b for further processing.

The information search engine 825 may be configured to determine information corresponding to the topic(s) of interest. The information search engine 825 may be configured to query the data sources 110 for information corresponding to the topic(s) of interest.

In some embodiments, the information search engine 825 may send a query request to one or more of the data sources 110. The information search engine 825 may generate the query request to include the topic(s) of interest, and send the generated query request to the data source 110. In response to receiving the query request, the data source 110 may search its available data for information corresponding to the topic(s) of interest. The data source 110 may send one or more search results to the information search engine 825 in response to the query request. If no search results are found, then the data source 110 may send an indication that no information was found. The information search engine 825 may determine the information 108 based on the search results received from the data source 110.

In some implementations, the information search engine 825 may search indexed data stored at the information search engine 825 or at a data storage associated with the information search engine 825. The stored indexed data may be based on information previously received from the data sources 110 in response to previous query requests made by the information search engine 825, and may indicate the data source 110 from which the information was received. In some embodiments, the stored indexed data may be retained for the duration of the online meeting, as such it may be based on query requests made during the instant online meeting and may relate to topics of interest to the user 102 during the instant online meeting. In some embodiments, the stored indexed data corresponding to publicly available data sources may be retained after the instant online meeting is over. In some embodiments, the indexed data may be associated with a user identifier for the user 102, so search results from the indexed data may be retrieved during subsequent online meetings for the user 102. In some implementations, the information search engine 825 may search the stored indexed data before sending a query request to the data sources 110 for information corresponding to the topic(s). If relevant information is found from the stored indexed data, then the information search engine 825 may not send the query request to the data sources 110. The information search engine 825 may determine the information 108 based on the search results from the stored indexed data.

In some cases, the information search engine 825 may not be able to send a query request directly to a data source. In some embodiments, the information search engine 825 may query the data sources 110 using an Application Programming Interface (API) request. An API component 835 may be configured to receive and route API requests, and receive and route responses to API requests. The information search engine 825 may generate an API request and send the API request to the API component 835. The generated API request may include the topic(s) of interest. In some implementations, the API request may also include a particular data source 110 to be searched. When the API request includes the particular data source 110, the API component 835 may send the API request to the indicated data source 110. When the API request does not include a particular data source, the API component 835 may send the API request to all of the available data sources 110. In response to receiving the API request, the data source 110 may search its available data (e.g., data stored at the data source 110 or at a data storage of the data source 110) for information corresponding to the topic(s) of interest included in the API request. The data source 110 may send, to the API component 835, one or more search results including information corresponding to the topic(s) of interest. If no search results are found, then the data source 110 may send, to the API component 835, an indication that no search results were found. The API component 835 may send the received search results to the information search engine 825 as a response to the API request. In some implementations, the API request may be in JSON. In some implementations, the API request may be a REST API request.

In some cases, one or more of the data sources 110 may require user authentication to search its data. In some embodiments, the API request, generated by the information search engine 825, may include user credentials or authorization tokens for the data source 110 to be searched. The user credentials or authorization token may be provided by the user credentials engine 815. The API component 835 may route the API request, including the user credentials or authorization token, to an authentication service 838, which may be configured to authenticate the user 102 for the data source 110. In some implementations, the authentication service 838 may perform an oAuth-based authentication. The authentication service 838 may send an indication, to the API component 835, of the authentication result. If the user 102 is successfully authenticated for the data source 110, then the API component 835 may send the API request to the data source 110. If authentication failed for the user 102 for the data source 110, then API component 835 may not send the API request to the data source 110. In some implementations, the API component 835 may send the API request to the data source 110 even when the user 102 is not authenticated, and the data source 110 may not send a response to the API request based on the user 102 not being authenticated. In some implementations, in response to receiving the API request, the data source 110 may request the authentication service 838 to authenticate the user 102.

The search results received by the information search engine 825 may include multiple different types of data. For example, the file sharing system 840 may send data corresponding to one or more files (e.g., links to the files, the files themselves, filenames, summary/description of the files, etc.) that relate to the topic(s) of interest. As a further example, the email system 842 may send data corresponding to one or more emails (e.g., links to the emails, the email themselves, subject lines, sender and recipient information, etc.) that relate to the topic(s) of interest. As another example, the intranet system 844 may send data corresponding to webpages (e.g., links to the webpages, title of the webpages, summary/description of the webpages, tags for the webpages, etc.) that relate to the topic(s) of interest. As another example, the web search engine 846 may data corresponding to publicly available websites (e.g., links to the websites, titles of the websites, summary/description of the websites, etc.).

The information search engine 825 may receive multiple different pieces of information (e.g., search results) from one or more of the data sources 110. The information search engine 825 may filter and/or rank the search results based on its respective relevancy to the topic of interest. To perform such filtering and ranking, the information search engine 825 may employ a rule-based engine and/or a machine learning model(s) that may be configured to determine a relevancy score for each search result based on the topic. In some implementations, the relevancy score may be based on a frequency of the topic appearing in the search result, semantic similarity between the search result and the topic, etc. The information search engine 825 may determine a list of search results to be presented to the user 102. The information search engine 825 may filter out the search results that are not relevant to the topic, for example, based on the corresponding relevancy score not satisfying a condition (e.g., being below a threshold level), and may include the remaining search results in the list to be presented to the user 102. In other implementations, the information search engine 825 may rank the search results based on the corresponding relevancy score, and may include the top n scoring search results in the list to be presented to the user 102. The information search engine 825 may also order the search results in the list to be presented to the user 102 based on the corresponding relevancy scores.

The information search engine 825 may determine the information 108 to include the list of search results for presentation to the user 102. The search results may be represented as selectable user interface elements, such as, hyperlinks or buttons. The information system 800b may send data corresponding to the list of search results to the meeting system 800a, which may send the data to the client device 202 for display. Based on receiving the data from the meeting system 800a, the client device 202 may display hyperlinks, buttons or other selectable user interface elements. Selection of the user interface element by the user 102 may direct the user 102 to the data source 110 from which the search result is retrieved.

The analytics engine 830 may be configured to track user interactions with the information 108 provided by the computing system(s) 100 at the client device 202 during online meetings. The analytics engine 830 may track user interactions on a user-basis, and may store data corresponding to the user interactions and associated with a particular user. For example, the analytics engine 830 may store first data corresponding to user interactions performed by the first user 102a, and second data corresponding to user interactions performed by the second user 102b. The analytics engine 830 may track selection(s), by the user 102, of the information 108 displayed at the client device 202. Based on the user interactions with the information 108, the analytics engine 830 may determine user preferences relating to the data sources 110. For example, the analytics engine 830 may determine, based on the user 102 selecting information from a particular data source 110 to view during the online meeting that the user 102 prefers to receive information from that data source 110. The analytics engine 830 may determine the user preferences based on user interactions tracked over multiple different online meetings. The analytics engine 830 may determine the user preferences based on a number of times the user 102 selects information from the particular data source 110, based on a number of times information is available from another data source and the user 102 selects information from the particular data source 110 instead, and other factors. In some implementations, the analytics engine 830 may determine the user preferences for a particular topic or a particular topic category. A topic category may be a group of related topics. For example, the analytics engine 830 may determine that the user 102 prefers to receive information from the particular data source 110 for a particular topic of interest. To make this determination, the analytics engine 830 may receive the topic of interest from the NLP engine 820 or the information search engine 825. In some implementations, the analytics engine 830 may determine the user preferences for a particular type of information.

The user preferences determined by the analytics engine 830 may be used by the information search engine 825 to filter and/or rank search results received from the data sources 110 in response to the information request. The information search engine 825 may use the user preferences during the instant online meeting or during future online meetings in which the user 102 participates. The information search engine 825 may receive multiple different pieces of information from the multiple data sources 110, and may filter the pieces of information to only include information from the data sources 110 that the user 102 prefers (based on the user preferences determined by the analytics engine 830). In other implementations, the information search engine 825 may determine an ordered list of information, where the information from the user's 102 preferred data source 110 is listed/ranked higher than information from other data sources 110. The information search engine 825 may also filter and/or rank the pieces of information based on the topic of interest.

In some implementations, the user preferences determined by the analytics engine 830 may be used to update one or more rules and/or one or more machine learning models employed by the information search engine 825 for filtering/ranking search results from the data sources 110.

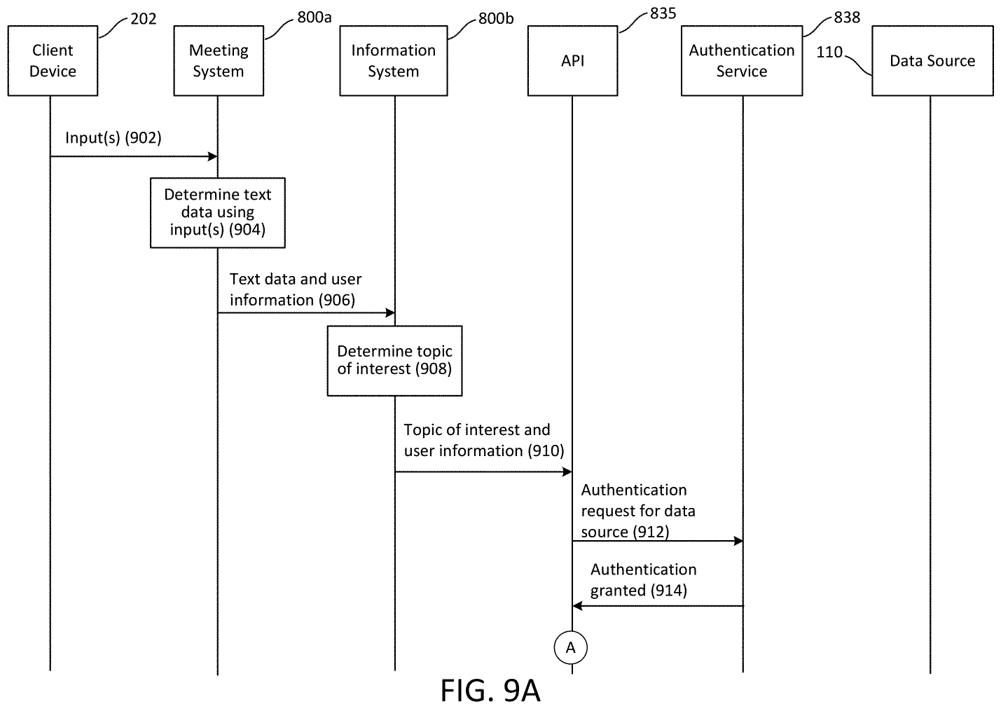

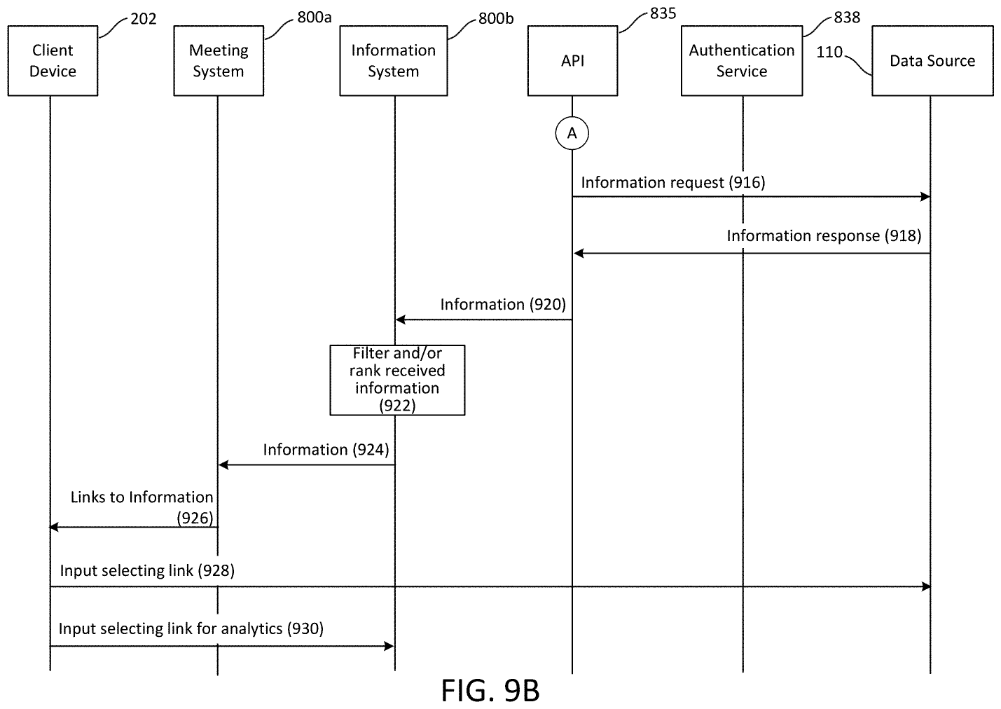

FIGS. 9A and 9B show an example signal diagram according to an example implementation of the system shown in FIG. 8. Referring to FIG. 9A, the client device 202 may send (902) one or more inputs 106 (shown in FIG. 1A) to the meeting system 800a. The inputs 106 may be speech inputs and/or other types of inputs provided by the user 102 during an online meeting being accessed at the client device 202 by the user 102. The meeting system 800a may determine (904) text data using the input(s) 106, where the text data may represent words spoken by the user 102 during the online meeting. In some implementations, the meeting system 800a may be configured to determine information corresponding to the user 102, such as, a user identifier, a user name, user credentials, etc. The meeting system 800a may send (906) the text data and the user information to the information system 800b.

The information system 800b may determine (908) one or more topics of interest using the text data. The information system 800b may send (910) the topic(s) of interest and the user information to the API component 835, as part of an API request. The API component 835 may send (912) an authentication request for the data source 110 to the authentication service 838. The authentication service 838 may authenticate the user 102 for the data source 110, and may send (914) an indication of authentication granted to the API component 835.

Now referring to FIG. 9B, the API component 835 may send (916) an information request to the data source 110, where the information request may include the topic(s) of interest. The data source 110 may send (918), to the API component 835, a response including information, such as, search results, corresponding to the topic(s) of interest. The API component 835 may send (920) the information to the information system 800b, and the information system 800b may filter and/or rank (922) the received information. The information system 800b may send (924) the information 108 (shown in FIG. 1A) to the meeting system 800a, where the information 108 may be derived after filtering/ranking the information received from the data source(s) 110.

The meeting system 800a may send (926) links to the information 108 to the client device 202 for presentation to the user 102 during the online meeting. The client device 202 may receive (from the user 102) and send (928) an input selecting a link to the data source 110, thus enabling the user 102 to access the corresponding information at the data source 110. The client device 202 may also send (930) the input selecting the link for analytics to the information system 800b.

With regards to FIG. 8, which shows an example implementation of the system for providing relevant information during an online meeting, in other example embodiments, one or more components shown in FIG. 8 may be disposed at any number of places/components with in the multi-resource access system 500 shown in FIGS. 5A-5C. For example, the meeting system 800a may be one of the resources that the user 102 accesses via the resource access application 522, and the data sources 110 may be other resources that the user 102 has access to via the resource access application 522. The information system 800b may be another resource that the user 102 can access and may have enabled to run/execute (in the background) while the user 102 participates in an online meeting. In an example embodiment, the data sources 110 may be the systems of record 526 shown in FIG. 5C, and the information system 800b may use the data integration provider service 530 and/or the credential wallet service 532 to gain access to the data sources 110 and authenticate the user 102, in a similar manner described above in relation to FIG. 5C (in Section E). The information 108 may be displayed at the client device 202 via the resource access application 522, where the information 108 may be presented as an overlay to the meeting application.

In yet other example embodiments, one or more components shown in FIG. 8 may be disposed at any number of places/components with in the resource delivery system 600 shown in FIGS. 6A-6E. For example, the meeting system 800a may be one of the shared computing resource 602 that the user 102 accesses via the resource access application 624 at the client device 202, and the data sources 110 may be other shared computing resources 602 that the user 102 has access to via the resource access application 624. The information system 800b may be another shared computing resource 602 that the user 102 can access and may have enabled to run/execute (in the background) while the user 102 participates in an online meeting. The meeting application, hosted by the meeting system 800a, may be delivered to the resource access application 624 via the connection 648. The information system 800b may gain access to the data sources 110 and authenticate the user 102 using the client access manager 610 and/or the resource delivery controller 612. The information 108 may be displayed at the client device 202 via the resource access application 624 as an overlay to the meeting application.

I. Example Implementations of Methods, Systems, and Computer-Readable Media in Accordance with the Present Disclosure

The following paragraphs (M1) through (M11) describe examples of methods that may be implemented in accordance with the present disclosure.

(M1) A method may be performed that involves at least one computing system determining, based at least in part on input provided to a meeting application, at least a first topic of interest for a first user accessing the meeting application via a first client device, in response to determining the first topic of interest, querying at least one data source, external to the meeting application, for information corresponding to the first topic of interest, and causing the first client device to display a representation of the information.

(M2) A method may be performed as described in paragraph (M1), and may further involve the at least one computing system receiving text data based on speech inputs provided by the first user to the meeting application, and in response to receiving the text data and without receiving further input from the first user, determining the first topic of interest based on the text data.

(M3) A method may be performed as described in paragraph (M2), wherein the text data corresponds to a portion of a transcript of an on-going online meeting being accessed by the first user via the meeting application.

(M4) A method may be performed as described in any of paragraphs (M1) through (M3), wherein the representation of the information is displayed at the first client device via the meeting application.

(M5) A method may be performed as described in any of paragraphs (M1) through (M4), wherein the representation of the information is displayed at the first client device via a user interface screen separate from the meeting application.

(M6) A method may be performed as described in any of paragraphs (M1) through (M5), wherein the first user is engaged, via the meeting application, in an online meeting with at least a second user, and the method may further involve the at least one computing system determining, based at least in part on input provided by the second user during the online meeting, at least a second topic of interest for the second user, in response to determining the second topic of interest, querying at least one other data source for other information corresponding to the second topic of interest, and causing a second client device operated by the second user to display a representation of the other information.

(M7) A method may be performed as described in any of paragraphs (M1) through (M6), wherein the first topic of interest is based on first inputs received from the first user at a first time during an online meeting, and the method may further involve the at least one computing system determining, based at least in part on second inputs received from the first user at a second time subsequent to the first time during the online meeting, at least a second topic of interest for the first user, in response to determining the second topic of interest, querying the at least one data source for additional information corresponding to the second topic, and causing the first client device to display a representation of the additional information causing the first client device to update a display with relevant information based on a change in a topic of interest.

(M8) A method may be performed as described in paragraph (M7), wherein the first input is a first speech input from the first user and the second input is a second speech input from the first user.

(M9) A method may be performed as described in any of paragraphs (M1) through (M8), and may further involve the at least one computing system receiving user credentials associated with the first user and a file sharing system, accessing the file sharing system using the user credentials, querying the file sharing system to retrieve a file corresponding to the first topic of interest, and causing the first client device to display a user interface element enabling the first user to view contents of the file by selecting the user interface element.

(M10) A method may be performed as described in any of paragraphs (M1) through (M9), and may further involve identifying a plurality of search results corresponding to the first topic, the plurality of search results being from more than one data source, determining past interaction data for the first user during past online meetings, the past interaction data indicative of search results selected by the first user during past online meetings, determining a ranked list of search results using the plurality of search results and the past interaction data, and causing the first client device to display the ranked list of search results.

(M11) A method may be performed as described in any of paragraphs (M1) through (M10), wherein querying the at least one data source comprises, sending, to the at least one data source, an API request to search for information corresponding to the first topic of interest.

The following paragraphs (S1) through (S11) describe examples of systems and devices that may be implemented in accordance with the present disclosure.

(S1) A computing system may comprise at least one processor and at least one computer-readable medium encoded with instructions which, when executed by the at least one processor, cause the computing system to determine, based at least in part on input provided to a meeting application, at least a first topic of interest for a first user accessing the meeting application via a first client device, in response to determining the first topic of interest, query at least one data source, external to the meeting application, for information corresponding to the first topic of interest, and cause the first client device to display a representation of the information.

(S2) A computing system may be configured as described in paragraph (S1), wherein the at least one computer-readable medium may be further encoded with additional instructions which, when executed by the at least one processor, further cause the computing system to receive text data based on speech inputs provided by the first user to the meeting application, and in response to receiving the text data and without receiving further input from the first user, determine the first topic of interest based on the text data.

(S3) A computing system may be configured as described in paragraph (S2), wherein the text data corresponds to a portion of a transcript of an on-going online meeting being accessed by the first user via the meeting application.

(S4) A computing system may be configured as described in any of paragraphs (S1) through (S3), wherein the representation of the information is displayed at the first client device via the meeting application.

(S5) A computing system may be configured as described in any of paragraphs (S1) through (S4), wherein the representation of the information is displayed at the first client device via a user interface screen separate from the meeting application.

(S6) A computing system may be configured as described in any of paragraphs (S1) through (S5), wherein the first user is engaged, via the meeting application, in an online meeting with at least a second user, and wherein the at least one computer-readable medium may be further encoded with additional instructions which, when executed by the at least one processor, further cause the computing system to determine, based at least in part on input provided by the second user during the online meeting, at least a second topic of interest for the second user, in response to determining the second topic of interest, query at least one other data source for other information corresponding to the second topic of interest, and cause a second client device operated by the second user to display a representation of the other information.

(S7) A computing system may be configured as described in any of paragraphs (S1) through (S6), wherein the first topic of interest is based on first inputs received from the first user at a first time during an online meeting, and wherein the at least one computer-readable medium may be further encoded with additional instructions which, when executed by the at least one processor, further cause the computing system to determine, based at least in part on second inputs received from the first user at a second time subsequent to the first time during the online meeting, at least a second topic of interest for the first user, in response to determining the second topic of interest, query the at least one data source for additional information corresponding to the second topic, and cause the first client device to display a representation of the additional information causing the first client device to update a display with relevant information based on a change in a topic of interest.

(S8) A computing system may be configured as described in paragraph (S7), wherein the first input is a first speech input from the first user and the second input is a second speech input from the first user.

(S9) A computing system may be configured as described in any of paragraphs (S1) through (S8), wherein the at least one computer-readable medium may be further encoded with additional instructions which, when executed by the at least one processor, further cause the computing system to receive user credentials associated with the first user and a file sharing system, access the file sharing system using the user credentials, query the file sharing system to retrieve a file corresponding to the first topic of interest, and cause the first client device to display a user interface element enabling the first user to view contents of the file by selecting the user interface element.

(S10) A computing system may be configured as described in any of paragraphs (S1) through (S9), wherein the at least one computer-readable medium may be further encoded with additional instructions which, when executed by the at least one processor, further cause the computing system to identify a plurality of search results corresponding to the first topic, the plurality of search results being from more than one data source, determine past interaction data for the first user during past online meetings, the past interaction data indicative of search results selected by the first user during past online meetings, determine a ranked list of search results using the plurality of search results and the past interaction data, and cause the first client device to display the ranked list of search results.

(S11) A computing system may be configured as described in any of paragraphs (S1) through (S10), wherein the instructions which, when executed by the at least one processor, cause the computing system to query the at least one data source, further causes the computing system to send, to the at least one data source, an API request to search for information corresponding to the first topic of interest.

The following paragraphs (CRM1) through (CRM11) describe examples of computer-readable media that may be implemented in accordance with the present disclosure.

(CRM1) At least one non-transitory computer-readable medium may be encoded with instructions which, when executed by at least one processor of a computing system, may cause the computing system to determine, based at least in part on input provided to a meeting application, at least a first topic of interest for a first user accessing the meeting application via a first client device, in response to determining the first topic of interest, query at least one data source, external to the meeting application, for information corresponding to the first topic of interest, and cause the first client device to display a representation of the information.

(CRM2) At least one non-transitory computer-readable medium may be configured as described in paragraph (CRM1), and may be further encoded with additional instructions which, when executed by the at least one processor, further cause the computing system to receive text data based on speech inputs provided by the first user to the meeting application, and in response to receiving the text data and without receiving further input from the first user, determine the first topic of interest based on the text data.

(CRM3) At least one non-transitory computer-readable medium may be configured as described in paragraph (CRM2), wherein the text data corresponds to a portion of a transcript of an on-going online meeting being accessed by the first user via the meeting application.

(CRM4) At least one non-transitory computer-readable medium may be configured as described in any of paragraphs (CRM1) through (CRM3), wherein the representation of the information is displayed at the first client device via the meeting application.

(CRM5) At least one non-transitory computer-readable medium may be configured as described in any of paragraphs (CRM1) through (CRM4), wherein the representation of the information is displayed at the first client device via a user interface screen separate from the meeting application.

(CRM6) At least one non-transitory computer-readable medium may be configured as described in any of paragraphs (CRM1) through (CRM5), wherein the first user is engaged, via the meeting application, in an online meeting with at least a second user, and the at least one non-transitory computer-readable medium may be further encoded with additional instructions which, when executed by the at least one processor, further cause the computing system to determine, based at least in part on input provided by the second user during the online meeting, at least a second topic of interest for the second user, in response to determining the second topic of interest, query at least one other data source for other information corresponding to the second topic of interest, and cause a second client device operated by the second user to display a representation of the other information.

(CRM7) At least one non-transitory computer-readable medium may be configured as described in any of paragraphs (CRM1) through (CRM6), wherein the first topic of interest is based on first inputs received from the first user at a first time during an online meeting, and the at least one non-transitory computer-readable medium may be further encoded with additional instructions which, when executed by the at least one processor, further cause the computing system to determine, based at least in part on second inputs received from the first user at a second time subsequent to the first time during the online meeting, at least a second topic of interest for the first user, in response to determining the second topic of interest, query the at least one data source for additional information corresponding to the second topic, and cause the first client device to display a representation of the additional information causing the first client device to update a display with relevant information based on a change in a topic of interest.

(CRM8) At least one non-transitory computer-readable medium may be configured as described in paragraph (CRM7), wherein the first input is a first speech input from the first user and the second input is a second speech input from the first user.

(CRM9) At least one non-transitory computer-readable medium may be configured as described in any of paragraphs through (CRM1) through (CRM8), and may be further encoded with additional instructions which, when executed by the at least one processor, further cause the computing system to receive user credentials associated with the first user and a file sharing system, access the file sharing system using the user credentials, query the file sharing system to retrieve a file corresponding to the first topic of interest, and cause the first client device to display a user interface element enabling the first user to view contents of the file by selecting the user interface element.

(CRM10) At least one non-transitory computer-readable medium may be configured as described in any of paragraphs (CRM1) through (CRM9), and may be further encoded with additional instructions which, when executed by the at least one processor, further cause the computing system to identify a plurality of search results corresponding to the first topic, the plurality of search results being from more than one data source, determine past interaction data for the first user during past online meetings, the past interaction data indicative of search results selected by the first user during past online meetings, determine a ranked list of search results using the plurality of search results and the past interaction data, and cause the first client device to display the ranked list of search results.

(CRM11) At least one non-transitory computer-readable medium may be configured as described in any of paragraphs (CRM1) through (CRM10), wherein the instructions which, when executed by the at least one processor, cause the computing system to query the at least one data source, further causes the computing system to send, to the at least one data source, an API request to search for information corresponding to the first topic of interest.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

1. A method comprising:
receiving, by a computing system, access credentials input by a first user to a first client device;
using, by the computing system, the access credentials to authenticate an identity of the first user;
in response to the computing system determining that the first client device has requested access to a meeting application and based at least in part on the identity of the first user having been authenticated using the access credentials, causing, by the computing system, the first client device to be provided with access to the meeting application using first stored authentication credentials associated with the first user;
determining, by the computing system and based at least in part on input provided to a meeting application, at least a first topic of interest for the first user accessing the meeting application via the first client device;
in response to determining the first topic of interest and based at least in part on the identity of the first user having been authenticated using the access credentials, causing, by the computing system, at least one data source, external to the meeting application, to be queried for information corresponding to the first topic of interest using second stored authentication credentials associated with the first user; and
causing, by the computing system, the first client device to display a representation of the information.

2. The method of claim 1, further comprising:
receiving, by the computing system, text data based on speech inputs provided by the first user to the meeting application; and
in response to receiving the text data and without receiving further input from the first user, determining, by the computing system, the first topic of interest based on the text data.

3. The method of claim 2, wherein the text data corresponds to a portion of a transcript of an on-going online meeting being accessed by the first user via the meeting application.

4. The method of claim 1, wherein the representation of the information is displayed at the first client device via the meeting application.

5. The method of claim 1, wherein the representation of the information is displayed at the first client device via a user interface screen separate from the meeting application.

6. The method of claim 1, wherein the first user is engaged, via the meeting application, in an online meeting with at least a second user, and the method further comprises:
determining, by the computing system and based at least in part on input provided by the second user during the online meeting, at least a second topic of interest for the second user;
in response to determining the second topic of interest, querying, by the computing system, at least one other data source for other information corresponding to the second topic of interest; and
causing, by the computing system, a second client device operated by the second user to display a representation of the other information.

7. The method of claim 1, wherein the first topic of interest is based on first inputs received from the first user at a first time during an online meeting, and the method further comprises:
determining, by the computing system and based at least in part on second inputs received from the first user at a second time subsequent to the first time during the online meeting, at least a second topic of interest for the first user;
in response to determining the second topic of interest and based at least in part on the identity of the first user having been authenticated using the access credentials, causing, by the computing system, at least one other data source to be queried for additional information corresponding to the second topic using third stored authentication credentials associated with the first user; and
causing, by the computing system, the first client device to display a representation of the additional information.

8. The method of claim 7, wherein the first inputs are first speech inputs from the first user and the second inputs are second speech inputs from the first user.

9. The method of claim 1, wherein the at least one data source comprises a file sharing system, and the method further comprises:
retrieving, by the computing system and from file sharing system, a file corresponding to the first topic of interest; and
causing, by the computing system, the first client device to display a user interface element enabling the first user to view contents of the file by selecting the user interface element.

10. The method of claim 1, further comprising:
identifying, by the computing system, a plurality of search results corresponding to the first topic, the plurality of search results being from more than one data source;
determining, by the computing system, past interaction data for the first user during past online meetings, the past interaction data indicative of search results selected by the first user during past online meetings;
determining, by the computing system, a ranked list of search results using the plurality of search results and the past interaction data; and
causing, by the computing system, the first client device to display the ranked list of search results.

11. The method of claim 1, wherein causing the at least one data source to be queried comprises, sending, to the at least one data source, an API request to search for information corresponding to the first topic of interest.

12. A computing system, comprising:
at least one processor; and
at least one computer-readable medium encoded with instructions which, when executed by the at least one processor, cause the computing system to:
receive access credentials input by a first user to a first client device,
use the access credentials to authenticate an identity of the first user,
in response to determining that the first client device has requested access to a meeting application and based at least in part on the identity of the first user having been authenticated using the access credentials, cause the first client device to be provided with access to the meeting application using first stored authentication credentials associated with the first user,
determine, based at least in part on input provided to a meeting application, at least a first topic of interest for the first user accessing the meeting application via the first client device,
in response to determining the first topic of interest and based at least in part on the identity of the first user having been authenticated using the access credentials, cause at least one data source, external to the meeting application, to be queried for information corresponding to the first topic of interest using second stored authentication credentials associated with the first user, and
cause the first client device to display a representation of the information.

13. The computing system of claim 12, wherein the at least one computer-readable medium is further encoded with additional instructions which, when executed by the at least one processor, further cause the computing system to:
receive text data based on speech inputs provided by the first user to the meeting application; and
in response to receiving the text data and without receiving further input from the first user, determine the first topic of interest based on the text data.

14. The computing system of claim 13, wherein the text data corresponds to a portion of a transcript of an on-going online meeting being accessed by the first user via the meeting application.

15. The computing system of claim 12, wherein the representation of the information is displayed at the first client device via the meeting application.

16. The computing system of claim 12, wherein the representation of the information is displayed at the first client device via a user interface screen separate from the meeting application.

17. The computing system of claim 12, wherein the first topic of interest is based on first inputs received from the first user at a first time during an online meeting, and wherein the at least one computer-readable medium is further encoded with additional instructions which, when executed by the at least one processor, further cause the computing system to:
determine, based at least in part on second inputs received from the first user at a second time subsequent to the first time during the online meeting, at least a second topic of interest for the first user;
in response to determining the second topic of interest and based at least in part on the identity of the first user having been authenticated using the access credentials, causing at least one other data source to be queried for additional information corresponding to the second topic using third stored authentication credentials associated with the first user; and
cause the first client device to display a representation of the additional information.

18. The computing system of claim 17, wherein the first inputs are first speech inputs from the first user and the second inputs are second speech inputs from the first user.

19. The computing system of claim 12, wherein the at least one computer-readable medium is further encoded with additional instructions which, when executed by the at least one processor, further cause the computing system to cause the at least one data source to be queried at least in part by sending, to the at least one data source, an API request to search for information corresponding to the first topic of interest.

20. At least one non-transitory computer-readable medium encoded with instructions which, when executed by at least one processor of a computing system, cause the computing system to:
receive access credentials input by a first user to a first client device;
use the access credentials to authenticate an identity of the first user;
in response to determining that the first client device has requested access to a meeting application and based at least in part on the identity of the first user having been authenticated using the access credentials, cause the first client device to be provided with access to the meeting application using first stored authentication credentials associated with the first user;
determine, based at least in part on input provided to the meeting application, at least a first topic of interest for the first user accessing the meeting application via the first client device;
in response to determining the first topic of interest and based at least in part on the identity of the first user having been authenticated using the access credentials, cause at least one data source, external to the meeting application, to be queried for information corresponding to the first topic of interest using second stored authentication credentials associated with the first user; and
cause the first client device to display a representation of the information.
